(19) United States
(12) Patent Application Publication
(10) Pub. No.: US 2025/0339882 A1
(43) Pub. Date: Nov. 6, 2025

(54) APPARATUS, SYSTEM, AND METHOD OF VEHICULAR IMAGING-DEVICE CLEANING

(71) Applicant: MobilEye Vision Technologies Ltd., Jerusalem (IL)

(72) Inventors: Mordechai Gablinger, Natanya (IL); Moshe Katiee, Har Gilo (IL)

(73) Assignee: MobilEye Vision Technologies Ltd., Jerusalem (IL)

(21) Appl. No.: 19/194,545

(22) Filed: Apr. 30, 2025

Related U.S. Application Data
(60) Provisional application No. 63/642,837, filed on May 5, 2024.

(51) Int. Cl. B08B 5/02

(52) U.S. Cl. CPC B08B 5/02

(57) ABSTRACT

For example, an imaging-device cleaning system may include a blower configured to provide an airflow to be applied onto a surface of an imaging device. For example, the imaging-device cleaning system may include a sprinkler configured to sprinkle a liquid onto the surface of the imaging device. For example, the imaging-device cleaning system may include a controller configured to control activation and deactivation of the blower and the sprinkler. For example, the controller may be configured to control activation of at least one of the blower or the sprinkler, for example, based on identification of a predefined blockage scenario in which at least part of a field of view of the imaging device is to be blocked by a substance on the surface.

### CROSS REFERENCE

This application claims the benefit of and priority from U.S. Provisional Patent Application No. 63/642,837 entitled “Apparatus, System, and Method of Vehicle Image-Sensor Lens Cleaning”, filed May 5, 2024, the entire disclosure of which is incorporated herein by reference.

### BACKGROUND

Some vehicles may include a camera lens cleaning system, which may be configured to clean a camera lens from dirt, mud, or the like.

The camera lens cleaning system may include a water sprinkler, which may be configured to spray water onto the camera lens.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a plurality of imaging devices, in accordance with some demonstrative aspects.

FIG. 2 is a schematic block diagram illustration of an imaging-device cleaning system, in accordance with some demonstrative aspects.

FIG. 3 is a schematic state-diagram illustration of a method of selectively activating one or more imaging-device cleaners, in accordance with some demonstrative aspects.

FIG. 4 is an illustration of three blockage states of a lens, in accordance with some demonstrative aspects.

FIG. 5 is an illustration of imaging-device cleaners installed on a vehicle, in accordance with some demonstrative aspects.

FIG. 6 is a schematic illustration of an imaging-device cleaning system, in accordance with some demonstrative aspects.

FIG. 7 is a schematic illustration of an imaging-device cleaner, in accordance with some demonstrative aspects.

FIG. 8 is a schematic illustration of an imaging-device cleaner system, in accordance with some demonstrative aspects.

FIG. 9 is a schematic illustration of a blower, in accordance with some demonstrative aspects.

FIGS. 10A, 10B, 10C, and 10D are schematic illustrations of a blower assembly, in accordance with some demonstrative aspects.

FIG. 10E schematically illustrates a cross-section of the blower assembly of FIGS. 10A-10D, and FIG. 10F schematically illustrates an external view of a housing of the blower assembly of FIGS. 10A-10D, in accordance with some demonstrative aspects.

FIGS. 11A, 11B, 11C, 11D, and 11E are schematic illustrations of implementations of a blower output adapter according to a plurality of installation configurations, in accordance with some demonstrative aspects.

FIGS. 12A, 12B, 12C, and 12D are schematic illustrations of an air nozzle, in accordance with some demonstrative aspects.

FIGS. 13A, 13B, and 13C are schematic illustrations of a nozzle assembly including an air nozzle and a sprinkler nozzle, in accordance with some demonstrative aspects.

FIGS. 14A, 14B, and 14C are schematic illustrations of an ultrasonic vibration assembly, in accordance with some demonstrative aspects.

FIG. 15 is a schematic illustration of a method of vehicular imaging-device cleaning, in accordance with some demonstrative aspects.

FIG. 16 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, an imaging device, a digital camera device, a video device, a camera module, a vehicular imaging device, a medical imaging device, an electronic device, a computing device, an integrated computing device, an integrated chip, electronic circuitry, a processing device, an electronic device, a mobile computer, a laptop computer, a notebook computer, a tablet computer, a handheld computer, a handheld device, a mobile or portable device, a consumer device, a Smartphone and the like.

Some aspects may be used in conjunction with image processing systems, vehicular image-processing systems, image capturing systems, vehicular image capturing systems, image-based sensors, vehicular image-based sensors, autonomous systems, robotic systems, detection systems, or the like.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

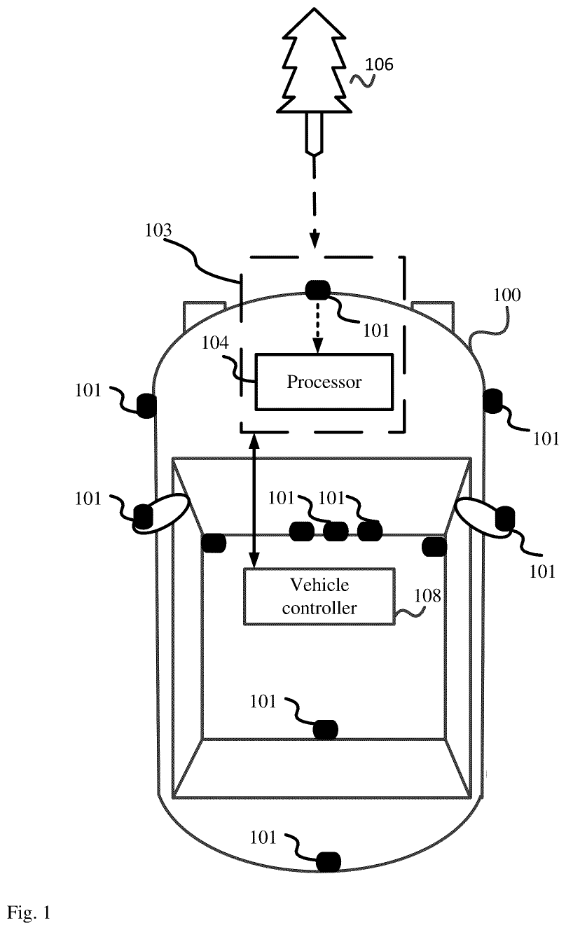

Reference is now made to FIG. 1, which schematically illustrates a block diagram of a vehicle 100 implementing an image-based control system 103 including a plurality of imaging devices 101, in accordance with some demonstrative aspects.

In some demonstrative aspects, image-based control system 103 may include a plurality of imaging devices 101, e.g., as shown in FIG. 1. In other aspects, image-based control system 103 may include a single imaging device 101.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, image-based control system 103 may be implemented as part of a vehicular system, for example, a system to be implemented and/or mounted in vehicle 100.

In one example, image-based control system 103 may be implemented as part of an autonomous vehicle system, an automated driving system, an assisted vehicle system, a driver assistance and/or support system, and/or the like.

For example, image-based control system 103 may be installed in vehicle 100 for detection of nearby objects, e.g., for autonomous driving.

In some demonstrative aspects, image-based control system 103 may be configured to detect targets in a vicinity of vehicle 100, e.g., in a far vicinity and/or a near vicinity, for example, using images, e.g., as described below.

In some demonstrative aspects, image-based control system 103 may include a plurality of imaging devices 101, which may be configured to cover a field of view of 360 degrees around vehicle 100.

In other aspects, image-based control system 103 may include any other suitable count, arrangement, and/or configuration of imaging devices and/or units, which may be suitable to cover any other field of view, e.g., a field of view of less than 360 degrees.

In some demonstrative aspects, image-based control system 103 may be implemented as a component in a suite of sensors used for driver assistance and/or autonomous vehicles.

In some demonstrative aspects, image-based control system 103 may be configured to support autonomous vehicle usage, e.g., as described below.

In one example, image-based control system 103 may determine a class, a location, a distance, a range, an orientation, a velocity, an intention, a perceptional understanding of the environment, and/or any other information corresponding to an object in the environment.

In another example, image-based control system 103 may be configured to determine one or more parameters and/or information for one or more operations and/or tasks, e.g., path planning, and/or any other tasks.

In some demonstrative aspects, image-based control system 103 may be configured to map a scene by measuring targets' reflectivity and discriminating them, for example, mainly in range, velocity, azimuth and/or elevation, e.g., as described below.

In some demonstrative aspects, image-based control system 103 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, an imaging device 101 may include a camera, an image-based detecting device, an image-based sensing device, or the like, which may be configured to capture one or more images e.g., as described below.

In one example, imaging devices 101 may be mounted onto, placed, e.g., directly, onto, or attached to, vehicle 100.

In some demonstrative aspects, image-based control system 103 may include at least one processor 104, which may be configured to generate image-based sensor information, for example, based on information corresponding to the captured images from one or more of the imaging devices 101.

In some demonstrative aspects, processor 104 may be configured to process the image-based sensor information of one or more imaging devices 101 and/or to control one or more operations of imaging devices 101.

In some demonstrative aspects, processor 104 may include, or may be implemented, partially or entirely, by circuitry and/or logic, e.g., one or more processors including circuitry and/or logic, memory circuitry and/or logic. Additionally or alternatively, one or more functionalities of processor 104 may be implemented by logic, which may be executed by a machine and/or one or more processors, e.g., as described below.

In one example, processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, processor 104 may be implemented by one or more additional or alternative elements of vehicle 100.

In some demonstrative aspects, as shown in FIG. 1, the imaging devices 101 may be controlled, e.g., by processor 104, to capture one or more images of an object 106.

In some demonstrative aspects, processor 104 may process the one or more images to generate sensor information, for example, by calculating information about position, radial velocity, and/or direction of the object 106, e.g., with respect to vehicle 100.

In some demonstrative aspects, processor 104 may be configured to provide the sensor information to a vehicle controller 108 of the vehicle 100, e.g., for autonomous driving of the vehicle 100.

In some demonstrative aspects, at least part of the functionality of processor 104 may be implemented as part of vehicle controller 108. In other aspects, the functionality of processor 104 may be implemented as part of any other element of image-based control system 103 and/or vehicle 100.

In some demonstrative aspects, vehicle controller 108 may be configured to control one or more functionalities, modes of operation, components, devices, systems and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a user interface, a steering system, a braking system, a driving system, and/or any other system of the vehicle 100.

In some demonstrative aspects, vehicle controller 108 may configured to control image-based control system 103, and/or to process one or more parameters, attributes and/or information from image-based control system 103.

In some demonstrative aspects, vehicle controller 108 may be configured, for example, to control the vehicular systems of the vehicle 100, for example, based on the image information from image-based control system 103 and/or one or more other sensors of the vehicle 100, e.g., radar sensors, Light Detection and Ranging (LiDAR) sensors, and/or the like.

In one example, vehicle controller 108 may control the user interface, the steering system, the braking system, and/or any other vehicular systems of vehicle 100, for example, based on the information from image-based control system 103, e.g., based on one or more objects detected by image-based control system 103.

In other aspects, vehicle controller 108 may be configured to control any other additional or alternative functionalities of vehicle 100.

In some demonstrative aspects, for example, in some implementations, scenarios, and/or use cases, the lens of an imaging device 101, and/or a surface covering the lens, e.g., a lens-protective surface or a lens radome, may be exposed to environment conditions of an environment of the vehicle 100.

For example, the lens of the imaging device 101, and/or the surface covering the lens, may be contaminated by foreign matter such as, for example, dust, mud, rain, snow, ice, insects, or the like. It would be appreciated that similar contamination can occur when any other additional or alternative surface along the optical path of the imaging device 101 is contaminated. In one example, contamination may occur with respect to a windshield of a vehicle, e.g., in case a camera is mounted within the vehicle and behind such windshield. In this regard, the term lens is sometimes used herein as an example of any surface along the optical path of an imaging device 101, which may have been contaminated in a manner which effects the ability of the imaging device 101 to provide an accurate (e.g., according to some criterion) representation of the scene within at least a part of a field of view of the imaging device 101.

For example, a field of view of the imaging device 101 may be obstructed by drops of liquid matter, e.g., rain, and/or particles of solid matter, e.g., mud or dust, on the lens of the imaging device 101, and/or the surface covering the lens.

In some demonstrative aspects, vehicle 100 and/or image-based control system 103 may include an imaging-device cleaning system, which may be configured to clean lenses and/or surfaces covering lenses of imaging devices 101, e.g., as described below.

Some demonstrative aspects are described herein with respect to an imaging-device cleaning system, which may be configured to clean a lens of an imaging device, e.g., as described below. In other aspects, the imaging-device cleaning system may be configured to clean any other additional or alternative surface of the imaging device, and/or a surface positioned in the optical path of the imaging device, for example, a surface covering, e.g., partially or entirely, the lens of the imaging device, for example, a protective surface, a radome or the like, e.g., as described below. Accordingly, some aspects described with respect to cleaning a lens of an imaging device may be interpreted with respect to cleaning a surface of the lens of the imaging device and/or cleaning a surface of the imaging device, for example, a protective surface of the imaging device, e.g., a radome or the like.

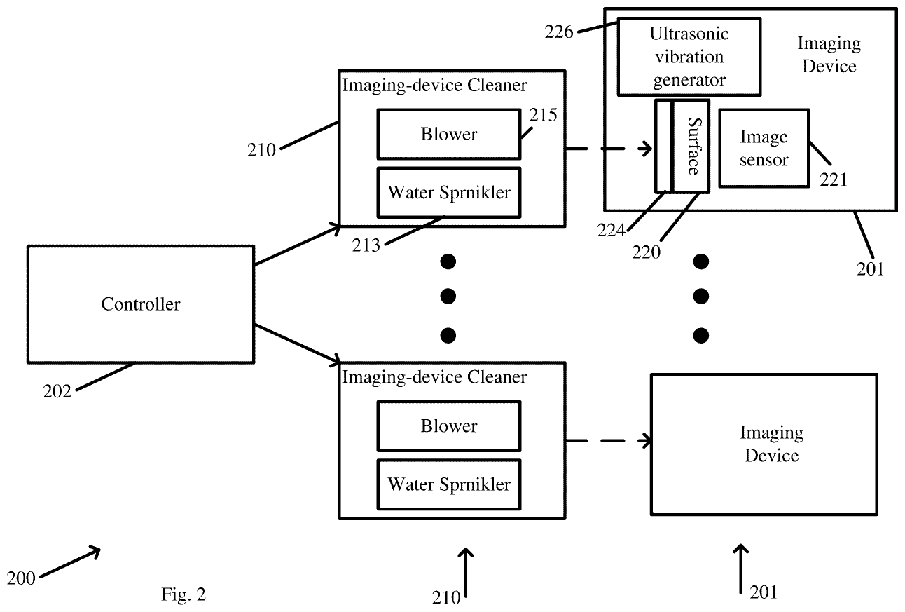

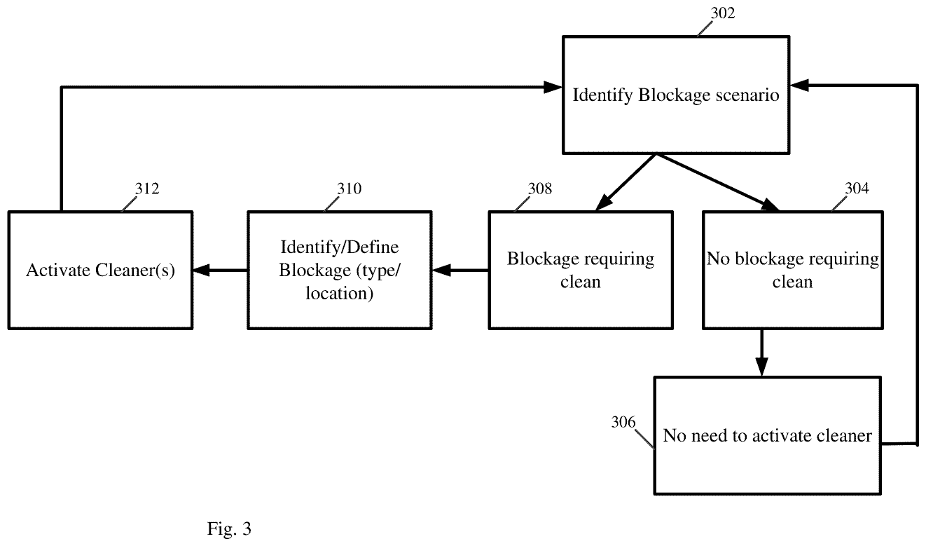

Reference is made to FIG. 2, which schematically illustrates an imaging-device cleaning system 200, in accordance with some demonstrative aspects.

In some demonstrative aspects, vehicle 100 (FIG. 1) and/or image-based control system 103 (FIG. 1) may be configured to implement one or more, e.g., some or all, components of the imaging-device cleaning system 200, and/or may perform one or more, e.g., some or all, functionalities of the imaging-device cleaning system 200.

In some demonstrative aspects, imaging-device cleaning system 200 may be configured to provide a technical solution to remove foreign matter, which may obstruct a field of view of one or more imaging devices 201, for example, in order to support proper functioning and/or performance of the imaging devices 201, e.g., as described below. For example, the imaging devices 201 may include one or more of the imaging devices 101 (FIG. 1).

In some demonstrative aspects, imaging-device cleaning system 200 may include a controller 202, which may be configured to control one or more imaging-device cleaners 210 to clean one or more surfaces 220, e.g., one or more lenses and/or one or more other surfaces in a field of view of the imaging devices 201, e.g., a lens-protective surface, a lens radome, or the like.

In some demonstrative aspects, controller 202 may include, or may be implemented, partially or entirely, by circuitry and/or logic, e.g., one or more processors including circuitry and/or logic, memory circuitry and/or logic. Additionally or alternatively, one or more functionalities of controller 202 may be implemented by logic, which may be executed by a machine and/or one or more processors, e.g., as described below.

In one example, controller 202 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, controller 202 may be implemented in the form of, or as part of, an Electronic Control Unit (ECU) and/or an Electronic Control Module (ECM).

In some demonstrative aspects, one or more functionalities of controller 202 may be implemented by processor 104 (FIG. 1).

In some demonstrative aspects, one or more functionalities of controller 202 may be implemented by vehicle controller 108 (FIG. 1).

In other aspects, controller 202 may be implemented by one or more additional or alternative elements of vehicle 100 (FIG. 1).

In some demonstrative aspects, as shown in FIG. 2, imaging-device cleaning system 200 may include a plurality of imaging-device cleaners 210 to clean a plurality of surfaces 220 of a plurality of imaging devices 201. For example, an imaging-device cleaner 210 may be implemented to clean a single respective surface 220, e.g., of a single imaging device 201.

In other aspects, an imaging-device cleaner 210 may be implemented to clean two or more surfaces 220, e.g., of two or more imaging devices 201.

In some demonstrative aspects, controller 202 may be configured to control a plurality of imaging-device cleaners 210, e.g., as shown in FIG. 2. In other aspects, controller 202 may be configured to control a single imaging-device cleaner 210, and/or two or more different imaging-device cleaners 210 may be controlled by two or more controllers 202. For example, in case multiple controllers are implemented, an individual controller can be operatively associated (and connected using necessary interfaces) to one or more other controllers, for example, such that the operation of one controller can affect the operation of another controller.

In some demonstrative aspects, controller 202 may be configured to identify a blockage scenario (use case) corresponding to a surface 220, for example, based on image information of an image captured by an image sensor 221 via the surface 220, e.g., as described below. The term “blockage” or the like as used here does not necessarily refer to full obstruction of relevant electromagnetic radiation from completely reaching a respective sensor. For example, in some implementations, use cases, and/or scenarios, the “blockage” may refer to any matter in any state interfering with electromagnetic radiation in a predefined manner, e.g., in manner that can impact, e.g., significantly impact, detection and/or identification of objects in the environment form which the electromagnetic radiation is reflected. For example, water droplets on a lens (cover) may not entirely block electromagnetic radiation from reaching a camera sensor, but some of the radiation could be blocked and/or refracted in a manner that makes it more difficult or impossible to robustly detect one or more objects in the environment of the vehicle, and in this regard, in the context of some demonstrative aspects, such water droplets can be considered a “blockage”. For example, an operational domain specification can be used to define what can be “acceptable” effects of blockage and/or which effects are beyond that which is acceptable and need to be identified and addressed by the controller 202. The operational domain specification can, for example, specify that a vehicle within the host vehicle's lane needs to be detected at least some distance (or a corresponding measure such as a minimum time to collision assuming worst case scenario) for ahead of the vehicle, and given various operational parameters of the imaging device 201, the ADAS or AV system and the host vehicle (and possibly also assumptions regarding the target vehicle) an “acceptable” block and “non-acceptable” blockage specification can be derived.

In some demonstrative aspects, the blockage scenario corresponding to the surface 220 may represent one or more characteristics of a blockage state of the surface 220, e.g., as described below.

In some demonstrative aspects, the blockage scenario corresponding to the surface 220 may represent a blockage level of the surface 220, e.g., as described below.

In one example, a first blockage-level scenario may include a no blockage (also referred to as “clean”) scenario, at which there may be substantially no blockage of the surface, e.g., the surface 220 may not be blocked by more than a predefined no-block level, which may represent a level at which the surface 220 may be considered non-blocked and/or clean.

In another example, a second blockage-level scenario may include a partial-blockage scenario, at which there may be up to some predefined level of blockage of the surface 220.

In another example, a third blockage-level scenario may include a full-blockage scenario, at which the blockage to the surface 220 may be above predefined level, e.g., at which the surface 220 may be considered to be fully blocked.

In another example, an estimated blockage location(s) on the respective surface can be estimated.

In other aspects, any other additional or alternative blockage-level scenarios may be defined.

In some demonstrative aspects, the blockage scenario corresponding to the surface 220 may represent a type of foreign matter causing blockage of the surface 220, e.g., as described below.

In one example, a first blockage-mater scenario may include a liquid blockage scenario, at which blockage may be caused by liquid matter, e.g., water.

In one example, a first blockage-mater scenario may include a solid blockage scenario, at which blockage may be caused by solid matter, e.g., dust, mud, ice, bird droppings, an insect, or the like.

In other aspects, any other additional or alternative blockage-matter scenarios may be defined.

In other aspects, any other additional or alternative types of blockage scenarios may be defined, e.g., based on any other additional or alternative characteristic of the blockage.

In some demonstrative aspects, controller 202 may be configured to control activation of the imaging-device cleaners 210, for example, based on one or more identified blockage scenarios corresponding to the one or more surfaces 220, e.g., as described below.

In some demonstrative aspects, controller 202 may be configured to control activation of the imaging-device cleaners 210, for example, based on one or more identified characteristics and/or parameters related to characteristics of an identified blockage, e.g., as described below.

In some demonstrative aspects, controller 202 may be configured to control selective activation of the imaging-device cleaners 210, for example, on a per surface basis, or a per imaging device basis, e.g., as described below.

For example, controller 202 may be configured to control activation of a first imaging-device cleaner 210 to clean a first surface 220 of a first imaging device 201, for example, based on determining a first blockage scenario of the first surface 220, e.g., which may require cleaning of the first surface 220.

For example, controller 202 may be configured to select not to activate a second imaging-device cleaner 210 to clean a second surface 220 of a second imaging device 201, for example, based on determining a second blockage scenario of the second surface 220, e.g., which may not require cleaning of the second surface 220.

In some demonstrative aspects, controller 202 may be configured to control selective activation of the imaging-device cleaners 210, for example, on a per-group basis, for example, by selectively activating one or more groups of imaging-device cleaners 210, e.g., as described below.

For example, controller 202 may be configured to select to activate a group of imaging-device cleaners 210 to clean a group of surfaces 220, for example, based on determining a blockage scenario of at least one surface of the group of surfaces 220, e.g., which may require cleaning of the group of surfaces 220.

In some demonstrative aspects, controller 202 may be configured to control collective activation of the plurality of imaging-device cleaners 210, e.g., as described below.

In other aspects, controller 202 may be configured to control activation of the plurality of imaging-device cleaners 210 according to any other activation scheme.

In some demonstrative aspects, controller 202 may be configured to control selective activation of the imaging-device cleaners 210, e.g., as described below.

Reference is made to FIG. 3, which schematically illustrates a method of selectively activating one or more imaging-device cleaners, in accordance with some demonstrative aspects. For example, controller 202 (FIG. 2) may be configured to perform one or more operations of the method of FIG. 3 to control selective activation of the imaging-device cleaners 210 (FIG. 2).

In some demonstrative aspects, as indicated at block 302, the method may include identifying a blockage scenario. For example, controller 202 (FIG. 2) may be configured to identify a blockage scenario, e.g., as described below.

In some demonstrative aspects, as indicated at block 304, the method may include determining that the identified blockage scenario does not require cleaning of a surface of an imaging device. For example, controller 202 (FIG. 2) may be configured to determine, e.g., based on the identified blockage scenario, that cleaning of a surface 220 (FIG. 2) is not required, e.g., as described below.

In some demonstrative aspects, as indicated at block 306, the method may include selecting not to activate an imaging-device cleaner, for example, based on the determination that the identified blockage scenario does not require cleaning of the surface of the imaging device. For example, controller 202 (FIG. 2) may be configured to select not to activate an imaging-device cleaner 210 (FIG. 2), for example, based on the determination that the identified blockage scenario does not require cleaning of the surface 220 (FIG. 2), e.g., as described below.

In some demonstrative aspects, as indicated at block 308, the method may include determining that the identified blockage scenario requires cleaning of a surface of an imaging device. For example, controller 202 (FIG. 2) may be configured to determine, e.g., based on the identified blockage scenario, that cleaning of a surface 220 (FIG. 2) is required, e.g., as described below.

In some demonstrative aspects, as indicated at block 310, the method may include identifying one or more attributes of the identified blockage scenario. For example, controller 202 (FIG. 2) may be configured to determine one or more attributes of the identified blockage scenario, for example, a type of blockage, a location, or the like, e.g., as described below.

In some demonstrative aspects, as indicated at block 312, the method may include activating at least one imaging device cleaner, for example, based on the one or more attributes of the identified blockage scenario. For example, controller 202 (FIG. 2) may be configured to activate at least one imaging-device cleaner 210 (FIG. 2), for example, based on one or more attributes of the identified blockage scenario, which requires cleaning of the surface 220 (FIG. 2), e.g., as described below.

Referring back to FIG. 2, in some demonstrative aspects, controller 202 may be configured to control activation of the imaging-device cleaners 210, for example, according to a control scheme, which may be defined according to a plurality of use cases, e.g., as described below.

In some demonstrative aspects, configuring the control scheme according to a plurality of use cases may provide a technical solution to tailor the surface cleaning, for example, on a per-use-case basis, for example, based on specific requirements with respect to blockage of the surface, which may be based on specific characteristics of a use case, e.g., as described below.

In some demonstrative aspects, configuring the control scheme according to a plurality of use cases may provide a technical solution to implement the surface cleaning, for example, in an efficient manner, for example, while efficiently utilizing system resources, e.g., electric power, e.g., as described below.

For example, upon research and investigation of a large number of use cases, the inventors have discovered that different use cases may result in different blockage possibilities, different blockage definitions, different cleaning requirements, and/or any other characteristics, which may have an effect on the cleaning mechanism.

In some demonstrative aspects, a use case may be defined based on a road type being driven by a vehicle.

In one example, a first use case may be defined with respect to a highway, e.g., where the probability of surface blockage due to mud or dust may be relatively low.

In another example, a second use case may be defined with respect to a dirt road, e.g., where the probability of surface blockage due to mud or dust may be relatively high.

In some demonstrative aspects, a use case may be defined based on a speed of the vehicle.

In one example, a first use case may be defined with respect to a high speed, e.g., above a predefined high speed threshold.

In another example, a second use case may be defined with respect to a low speed, e.g., below a predefined low speed threshold.

In some demonstrative aspects, a use case may be defined based on a weather condition.

In one example, a first use case may be defined with respect to a dry weather, e.g., where the probability of surface blockage due to rain and/or mud may be very low.

In another example, a second use case may be defined with respect to a rainy weather, e.g., where the probability of surface blockage due to rain and/or mud may be very high.

In some demonstrative aspects, a use case may be defined based on ambient temperature.

In one example, a first use case may be defined with respect to low temperatures, e.g., where the probability of surface blockage due to ice may be high.

In another example, a second use case may be defined with respect to high temperatures, e.g., where the probability of surface blockage due to ice may be low.

For example, a first use case may include driving on a paved road at a speed between 0-100 kilometers per hour (kph) on a dry hot day.

For example, a second use case may include driving on a paved road at a speed between 0-100 kph on a cold rainy day.

For example, a third use case may include driving on a dirt road at a speed between 0-50 kph on a cold dry day.

For example, a fourth use case may include driving on a dirt road at a speed between 0-50 kph on a hot rainy day.

In some demonstrative aspects, a use case may be defined based on a type of foreign matter contaminating the surface 220.

For example, the foreign matter may include solid dirt, water drops, sprinkles from the road and/or other cars, e.g., including water, mud, oil, salt and/or any other substance. In other aspects, any other additional or alternative use cases may be defined.

In some demonstrative aspects, imaging-device cleaning system 200 may be configured to provide a technical solution, which may be adaptable and/or reconfigurable, for example, based on changes and/or redefinition of one or more use cases and/or requirements corresponding to the use cases.

In some demonstrative aspects, controller 202 may be configured to control activation of the imaging-device cleaners 210, for example, according to a definition of one or more types of blockage, e.g., as described below.

For example, upon research and investigation of a large number of use cases, the inventors have discovered that, for example, in some implementations, there may be a need to remove from one or more locations, e.g., from substantially any location, on the surface 220 solid matter, e.g., water drops or dirt, which may have a diameter of as low as about 200 micrometer (um), e.g., regardless of the location on the surface 220.

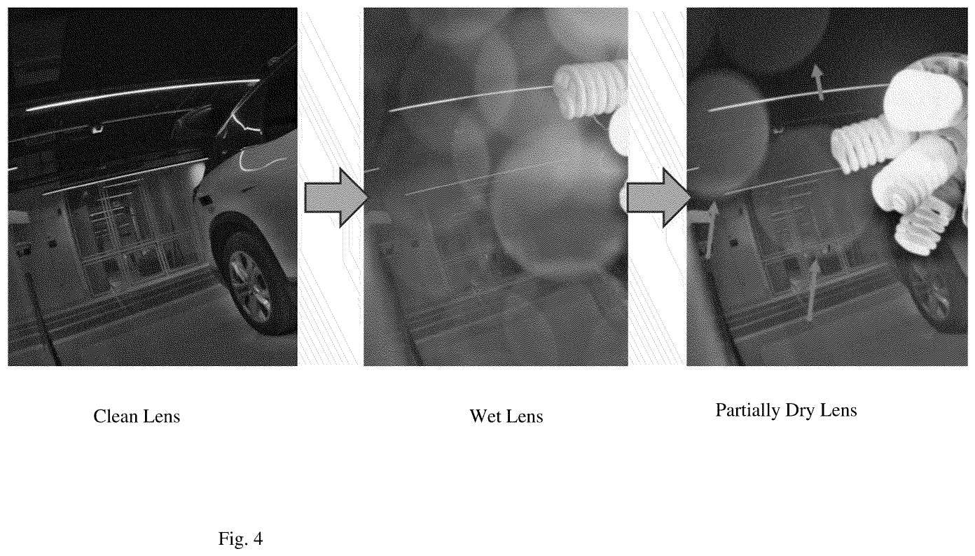

For example, as shown in FIG. 4, even a relatively small number of small water drops, may result in a degraded image, for example, in situations of glare, e.g., from vehicle lights, street lights, tunnel lights, or the like.

In some demonstrative aspects, controller 202 may be configured to control activation of the imaging-device cleaners 210, for example, according to a definition of a surface blockage to include any foreign matter, e.g., water drops or solid dirt, with a diameter equal to or larger than a predefined threshold.

In some demonstrative aspects, it may be defined that any foreign matter, e.g., water drops or solid dirt, with a diameter equal to or larger than 200 um is to be defined as a blocking foreign matter, which should be removed.

In other aspect, any other blockage threshold may be implemented.

In some demonstrative aspects, controller 202 may be configured to control activation of the imaging-device cleaners 210, for example, according to a definition of a type of water drops causing blockage.

In one example, a first type of water drops may include rain drops.

In another example, a second type of water drops may include water sprinkles from the road.

In another example, a third type of water drops may include water drops from splash.

In other aspects, any other type of water drops may be defined.

In some demonstrative aspects, controller 202 may be configured to control activation of the imaging-device cleaners 210, for example, according to a definition of a type of solid dirt causing blockage.

In one example, a first type of solid dirt may include dust.

In another example, a second type of solid dirt may include mud.

In another example, a third type of solid dirt may include insects.

In another example, a fourth type of solid dirt may include bird droppings.

In another example, a fifth type of solid dirt may include salt.

In another example, a sixth type of solid dirt may include oil.

In other aspects, any other type of solid dirt may be defined.

In some demonstrative aspects, imaging-device cleaning system 200 may be configured to implement one or more components and/or functionalities, which may be configured to provide a technical solution to remove blockage from surface 220, e.g., by changing a state of the surface 220 from dirty/blocked to clean, for example, to support continued driving with proper performance of the imaging device, e.g., as described below.

In some demonstrative aspects, imaging-device cleaning system 200 may be configured to implement one or more components and/or functionalities, which may be configured to provide a technical solution, which may be implemented with an automotive grade, e.g., as described below.

In some demonstrative aspects, imaging-device cleaning system 200 may be configured to implement one or more components and/or functionalities, which may be configured to provide a technical solution with relatively quiet operation, for example, at or below a predefined noise level, for example, at a noise level of about 50 decibel (dB) or less.

In some demonstrative aspects, imaging-device cleaning system 200 may be configured to implement one or more components and/or functionalities, which may be configured to provide a technical solution with relatively low power consumption, e.g., as described below.

In some demonstrative aspects, imaging-device cleaning system 200 may be configured to implement one or more components and/or functionalities, which may be configured to provide a technical solution with relatively low weight and/or size, e.g., as described below.

In some demonstrative aspects, imaging-device cleaning system 200 may be configured to implement one or more components and/or functionalities, which may be configured to provide a technical solution to support separate, controllable, and/or selective cleaning of a surface 220, e.g., each surface 220, e.g., as described below.

In some demonstrative aspects, imaging-device cleaning system 200 may be configured to implement one or more components and/or functionalities, which may be configured to provide a technical solution to support cleaning a group of two or more surfaces 220 substantially simultaneously, e.g., as described below. In some examples, such simultaneous cleaning can be controlled in a manner to maintain the overall noise level below a predetermined threshold. In one example, the noise level can be determined from a typical position of a driver, or user, e.g., in case of an Autonomous Vehicle (AV), or a driver's ears inside a vehicle, e.g., a particular vehicle or some representative model of a vehicle. In another example, the noise level can be determined from a typical position of any occupant of a vehicle, or user in case of an AV, or an occupant's ears. In other aspects, the noise level can be measured, using, for example, a microphone or an array of microphones within the host vehicle.

In some demonstrative aspects, imaging-device cleaning system 200 may be configured to implement one or more components and/or functionalities, which may be configured to provide a technical solution to support cleaning all surfaces 220 substantially simultaneously, e.g., as described below.

In some demonstrative aspects, imaging-device cleaning system 200 may be configured to implement one or more components and/or functionalities, which may be configured to provide a technical solution utilizing passive elements and/or long-lasting elements, e.g., as much as possible.

In some demonstrative aspects, imaging-device cleaning system 200 may be configured to implement one or more components and/or functionalities, which may be configured to provide a technical solution having simple and/or inexpensive assembly/disassembly, e.g., as described below.

In some demonstrative aspects, imaging-device cleaning system 200 may be configured to implement one or more components and/or functionalities, which may be configured to provide a technical solution having simple and/or low-cost maintenance, e.g., as described below.

In some demonstrative aspects, imaging-device cleaning system 200 may be configured to implement one or more components and/or functionalities, which may be configured to provide a technical solution having a relatively long operational lifetime, for example, at least one year, at least two years, and/or any other time period, e.g., as described below.

For example, an operation lifetime of about 1200-1500 hours may be supported, e.g., assuming 6-8 hours of daily operation, e.g., during three winter months, and about 3-4 hours of daily operation during six spring/autumn months, and 0.5 hours of daily operation during three summer months.

In some demonstrative aspects, imaging-device cleaning system 200 may be configured to implement one or more components and/or functionalities, which may be configured to provide a technical solution to support single-mode and/or continuous-mode operation, e.g., as described below.

In some demonstrative aspects, imaging-device cleaning system 200 may be configured to implement one or more components and/or functionalities, which may be configured to provide a technical solution to address technical issues and/or technical deficiencies of one or more other types of systems, e.g., as described below.

For example, a cleaning system, which is based on a water sprinkler and compressed air from an air compressor, may not be suitable for many vehicular implementations. For example, the air compressor may be very noisy, and may have a very high power consumption. For example, cleaning systems based on the air compressor may require complex installation and maintenance procedures. For example, cleaning systems based on the air compressor may be relatively big, e.g., due to the size of the compressor. For example, cleaning systems based on the air compressor may not be able to provide sufficient control on the pressure of the discharged air. For example, cleaning systems based on the air compressor may not be able to support automotive grade cleaning requirements.

For example, a shielding system, which utilizes physical shield elements to protect the lens from foreign matter, may not be suitable for many vehicular implementations, or for some types of cameras, e.g., used onboard vehicles for Advanced Driver-Assistance System (ADAS) and/or AV applications. For example, the physical shield elements may block part of the field of view of the imaging device and, accordingly, these physical shield elements may not be implemented in case a relatively large field of view is required.

In some demonstrative aspects, imaging-device cleaning system 200 may be configured to implement an imaging-device cleaner 210, for example, on a per imaging device basis 201, e.g., as described below.

For example, imaging-device cleaning system 200 may be configured to include a plurality of imaging-device cleaners 210 to clean a respective plurality of surfaces 220, which may correspond to a respective plurality of imaging devices 201. For example, an imaging-device cleaner 210, e.g., each imaging-device cleaner 210, may be controlled and/or operated individually, or as part of a group of cleaners including two or more cleaners, e.g., which may be used for cleaning two or more respective imaging devices.

For example, an imaging-device cleaner 210 may be configured as a dedicated (“private” or “individual”) imaging device cleaner, which may be dedicated to cleaning a particular surface 220 of a particular imaging device 201.

In some demonstrative aspects, the imaging-device cleaners 210 may be configured for installation in relative proximity to the imaging devices 201, e.g., as described below.

For example, the imaging-device cleaners 210 may be configured to have a size and shape, which may be suitable for installation at one or more locations of a vehicle.

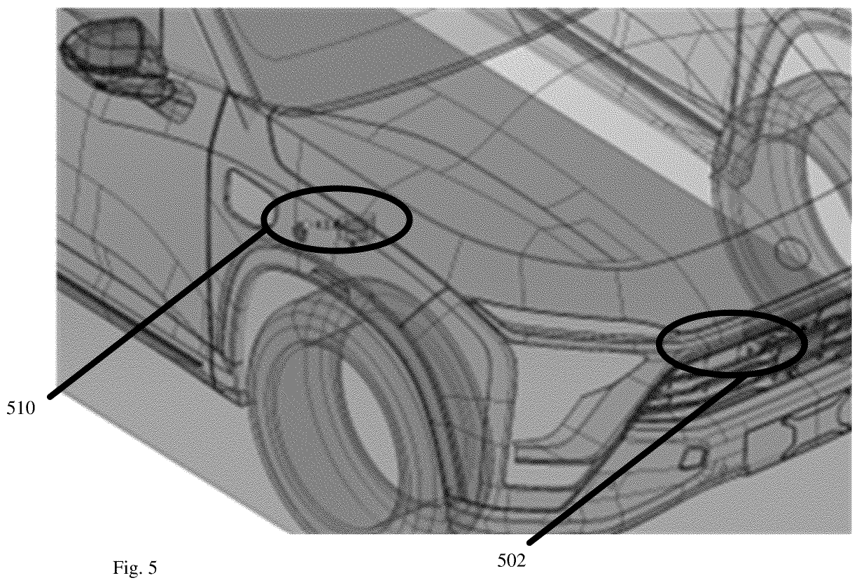

In one example, as shown in FIG. 5, the imaging-device cleaner 210 may be configured to have a size and shape, which may be suitable for installation (502) behind a front fascia of the vehicle, for example, for cleaning the surface of an imaging device 201 located at the front fascia of the vehicle.

In another example, the imaging-device cleaner 210 may be configured to have a size and shape, which may be suitable for installation behind a back fascia of the vehicle, for example, for cleaning the surface of an imaging device 201 located at the back fascia of the vehicle.

In another example, as shown in FIG. 5, the imaging-device cleaner 210 may be configured to have a size and shape, which may be suitable for installation (510) behind a fender of the vehicle, for example, for cleaning the surface of an imaging device 201 located on a side mirror of the vehicle.

In another example, the imaging-device cleaner 210 may be configured to have a size and shape, which may be suitable for installation in a door of the vehicle, for example, for cleaning the surface of an imaging device 201 located on a side mirror of the vehicle.

In another example, the imaging-device cleaner 210 may be configured to have a size and shape, which may be suitable for installation in a side mirror of the vehicle, for example, for cleaning the surface of an imaging device 201 located on a side mirror of the vehicle.

In another example, the imaging-device cleaner 210 may be configured to have a size and shape, which may be suitable for installation in the roof of the vehicle, for example, for cleaning the surface of an imaging device 201 located in or on the roof of the vehicle.

In some demonstrative aspects, the controller 202 may be electrically connected to two or more, e.g., some or all, of the plurality of imaging-device cleaners 210, for example, such that controller 202 may be able to collectively and/or centrally control the operation of the two or more imaging-device cleaners 210, for example, by individually controlling each one of the two or more imaging-device cleaners 210, and/or by controlling the plurality of imaging-device cleaners as a group or a plurality of groups.

In some demonstrative aspects, imaging-device cleaning system 200 may include one or more cleaning mechanisms, which may be configured to clean a surface 220 of an imaging device 201, e.g., as described below.

In some demonstrative aspects, imaging-device cleaning system 200 may include one or more, e.g., some or all, of a plurality of cleaning mechanisms, which may be configured to clean a surface 220 of an imaging device 201, e.g., as described below.

In some demonstrative aspects, imaging-device cleaning system 200 may include one or more, e.g., some or all, of four cleaning mechanisms, which may be configured to clean a surface 220 of an imaging device 201, e.g., as described below.

In some demonstrative aspects, imaging-device cleaning system 200 may include a combination of a plurality of cleaning mechanisms, e.g., two, three, or four cleaning mechanisms, or any other count of cleaning mechanisms, which may be implemented, for example, per imaging device 201, e.g., as described below.

In other aspects, imaging-device cleaning system 200 may include only some, e.g., only one or more than one, of the four cleaning mechanisms, and/or any other additional or alternative suitable cleaning mechanism.

In some demonstrative aspects, imaging-device cleaning system 200 may include a sprinkler 213, e.g., a water sprinkler 213, which may be configured to sprinkle liquid, e.g., water and/or a soap solution, onto the surface 220 of an imaging device 201, e.g., as described below.

In some demonstrative aspects, as shown in FIG. 2, the imaging-device cleaner 210 may include the sprinkler 213, e.g., as described below.

In some demonstrative aspects, sprinkler 213 may be configured to sprinkle liquid, e.g., high-pressured water, onto the surface 220.

In some demonstrative aspects, imaging-device cleaning system 200 may include a blower mechanism 215, which may be configured to blow air onto the surface 220 of an imaging device 201, e.g., as described below.

In some demonstrative aspects, as shown in FIG. 2, the imaging-device cleaner 210 may include the blower mechanism 215, e.g., as described below.

In some demonstrative aspects, blower mechanism 215 may be configured to remove liquid, e.g., water drops, from the surface 220, for example, by blowing high-pressured air onto the surface 220, e.g., as described below.

For example, the blower mechanism 215 may include a blower (not shown in FIG. 2) to provide the high-pressured air, a pipe (not shown in FIG. 2), to direct the high-pressured air from the blower towards the surface 220, and an air outlet, e.g., an air nozzle, (not shown in FIG. 2) to direct the high-pressured air onto the surface 220, e.g., as described below.

For example, the pipe of the blower mechanism 215 may be configured to have a relatively low friction coefficient, e.g., to provide a technical solution to convey the high-pressured air with reduced loss of pressure, e.g., as described below.

For example, the air outlet of the blower mechanism 215 may be configured to disperse the high-pressure air onto the surface 220, for example, in a substantially uniform pattern or any other suitable pattern, e.g., as described below.

In some demonstrative aspects, imaging-device cleaning system 200 may include an ultrasonic vibration generator 226, which may be configured to remove and/or evaporate by vibrations foreign matter from the surface 220, e.g., as described below.

In some demonstrative aspects, ultrasonic vibration generator 226 may be configured to vibrate the surface 220, e.g., at relatively high vibration frequency, for example, along an optical axis of the surface 220.

In some demonstrative aspects, ultrasonic vibration generator 226 may be configured to vibrate the surface 220, e.g., at relatively high vibration frequency, which may be configured, for example, to remove foreign matter from an outer surface 220, e.g., as described below.

For example, the ultrasonic vibration generator 226 may be configured to generate vibrations, for example, such that a kinetic energy of the vibrations may be converted into heat sufficient to cause evaporation of water drops on the surface 220.

In some demonstrative aspects, the ultrasonic vibration generator 226 may be utilized to remove drops, e.g., water drops, from an outer surface 220, to remove ice from the outer surface 220, and/or to remove vapor from an inner surface 220.

For example, controller 202 may be configured to operate the ultrasonic vibration generator 226 at a first predefined vibration frequency, which may be configured to remove drops, e.g., water drops, from an outer surface 220.

For example, controller 202 may be configured to operate the ultrasonic vibration generator 226 at a second predefined vibration frequency, e.g., different from the first vibration frequency, which may be configured to remove ice from an outer surface 220.

For example, controller 202 may be configured to operate the ultrasonic vibration generator 226 at a third predefined vibration frequency, e.g., different from the first and/or second vibration frequencies, which may be configured to remove vapor from an inner surface 220.

In some demonstrative aspects, ultrasonic vibration generator 226 may be configured to vibrate a dedicated window, which may be placed over the surface 220, for example, to remove foreign matter from an outer surface of the dedicated window, e.g., as described below.

In some demonstrative aspects, imaging-device cleaning system 200 may include a hydrophobic coating 224, which may be configured to repel liquid matter, e.g., water, from the surface 220, e.g., as described below.

In some demonstrative aspects, as shown in FIG. 2, the hydrophobic coating 224 may be implemented, for example, as a coating applied to surface 220, e.g., as described below.

In some demonstrative aspects, the hydrophobic coating 224 may be implemented to provide a technical solution to remove drops, e.g., water drops, from the surface 220. For example, the hydrophobic coating 224 may be configured to reduce a surface tension of a drop, e.g., a water drop, for example, to support removal of the drop from the surface 220, e.g., by the blower mechanism 215 and/or the ultrasonic vibration generator 226.

In some demonstrative aspects, imaging-device cleaning system 200 may be configured to utilize a combination of mechanisms, for example, including two or more of the sprinkler 213, the hydrophobic coating 224, the blower mechanism 215, and/or the ultrasonic vibration generator 226, e.g., as described below.

In one example, imaging-device cleaning system 200 may be configured to utilize a combination of the sprinkler 213, and the blower mechanism 215.

In another example, imaging-device cleaning system 200 may be configured to utilize a combination of the sprinkler 213, the hydrophobic coating 224, and the blower mechanism 215.

In another example, imaging-device cleaning system 200 may be configured to utilize a combination of the sprinkler 213, the blower mechanism 215, and the ultrasonic vibration generator 226.

In another example, imaging-device cleaning system 200 may be configured to utilize a combination of the sprinkler 213, the hydrophobic coating 224, the blower mechanism 215, and the ultrasonic vibration generator 226.

In some demonstrative aspects, controller 202 may be configured to activate the sprinkler 213, for example, to remove solid matter, e.g., mud, dust, bird droppings, insects or the like, from the surface 220.

In some demonstrative aspects, controller 202 may be configured to selectively activate a sprinkler 213 corresponding to a surface 220, for example, based on an identified use case, in which the surface 220 is determined to be contaminated with the solid matter.

In some demonstrative aspects, controller 202 may be configured to activate the blower mechanism 215 and/or the ultrasonic vibration generator 226, for example, to remove liquid matter, e.g., drops, from the surface 220.

In some demonstrative aspects, controller 202 may be configured to selectively activate a blower mechanism 215 and/or an ultrasonic vibration generator 226 corresponding to a surface 220, for example, based on an identified use case, in which the surface 220 is determined to be contaminated with liquid matter, e.g., water drops.

In some demonstrative aspects, although blower mechanism 215 and ultrasonic vibration generator 226 may provide similar technical results for removal of liquid matter, e.g., water drops, from the surface 220, an implementation of imaging-device cleaning system 200 including both the blower mechanism 215 and ultrasonic vibration generator 226 may provide one or more technical advantages, for example, for efficient removal of liquid matter, e.g., water drops, at one or more use cases and/or scenarios, e.g., as described below.

For example, upon research and investigation of a large number of use cases, the inventors have discovered that an implementation of imaging-device cleaning system 200 including both the blower mechanism 215 and the ultrasonic vibration generator 226 may provide a technical solution, which may be effective for a wide range of use cases, for example, including one or more use cases where the blower mechanism 215 may provide better results and/or may be more efficient, one or more use cases where the ultrasonic vibration generator 226 may provide better results and/or may be more efficient, and/or may produce a noise level that is less than a desired threshold while achieved good results and/or meeting power economics demands, e.g., as described below.

For example, upon research and investigation of a large number of use cases, the inventors have discovered that an implementation of imaging-device cleaning system 200 including both the blower mechanism 215 and the ultrasonic vibration generator 226 may provide a technical solution, which may support one or more use cases, in which the blower mechanism 215 may be activated, e.g., while the ultrasonic vibration generator 226 may not be activated, e.g., as described below.

For example, upon research and investigation of a large number of use cases, the inventors have discovered that an implementation of imaging-device cleaning system 200 including both the blower mechanism 215 and the ultrasonic vibration generator 226 may provide a technical solution, which may support one or more use cases, in which the ultrasonic vibration generator 226 may be activated, e.g., while the blower mechanism 215 may not be activated, e.g., as described below.

For example, upon research and investigation of a large number of use cases, the inventors have discovered that an implementation of imaging-device cleaning system 200 including both the blower mechanism 215 and the ultrasonic vibration generator 226 may provide a technical solution, which may support one or more use cases, e.g., extreme use cases, in which both the blower mechanism 215 and ultrasonic vibration generator 226 may be activated, e.g., simultaneously.

For example, the ultrasonic vibration generator 226 may be characterized by a lower noise level and/or a lower power consumption, e.g., compared to the blower mechanism 215, for example, while providing comparable or even better cleaning results.

For example, the blower mechanism 215 may be characterized by improved cleaning performance, for example, for quicker removal of a larger amount of water drops, e.g., compared to the ultrasonic vibration generator 226.

For example, the blower mechanism 215 can be configured to provide good removal capabilities for certain cleaning requirements, and the ultrasonic vibration generator 226 can be configured to provide good removal capabilities for certain other cleaning requirements.

For example, the blower mechanism 215 and the ultrasonic vibration generator 226 can be configured to work in combination to provide good removal capabilities for certain cleaning requirements, which each of these mechanisms is less capable of handling alone. In one example, the imaging-device cleaning system 200 may use the blower mechanism 215 and the vibration generator 226, together, possibly also with other mechanisms, e.g., the sprinklers, to remove an obstruction, for example, in case when the imaging-device cleaning system 200 recognizes a particularly challenging obstruction or an obstruction of a particular type, size or shape, and/or in case when the imaging-device cleaning system 200 attempted to remove the obstruction with each of the mechanisms alone and failed.

In some demonstrative aspects, controller 202 may be configured to selectively activate the blower mechanism 215 and/or the ultrasonic vibration generator 226, for example, according to a criterion, which may be based on a trade-off between the cleaning performance and the noise level/power consumption.

In some demonstrative aspects, controller 202 may be configured to selectively activate the blower mechanism 215 and/or the ultrasonic vibration generator 226, for example, according to an activation scheme, which may be tailored to a use case, e.g., as described below.

In some demonstrative aspects, controller 202 may be configured to selectively activate the blower mechanism 215 and/or the ultrasonic vibration generator 226, for example, according to an activation scheme, which may be configured to provide a technical solution, which may be tailored to the use case, for example, to provide a required cleaning performance for the use case, while reducing, e.g., minimizing, the power consumption and/or the noise level, e.g., as described below.

In one example, controller 202 may be configured to selectively activate the ultrasonic vibration generator 226, while maintaining the blower mechanism 215 non-active, for example, based on identification of a use case, which may require the removal of a relatively small amount of water drops, e.g., which may be efficiently handled by the ultrasonic vibration generator 226. For example, this activation scheme may provide a technical solution, which may be tailored to the use case, e.g., in terms of cleaning performance, while utilizing reduced power consumption and generating a reduced level of noise.

In another example, controller 202 may be configured to selectively activate the blower mechanism 215, while maintaining the ultrasonic vibration generator 226 non-active, for example, based on identification of a use case, which may require the removal of a relatively large amount of water drops, e.g., which may not be efficiently handled by the ultrasonic vibration generator 226. For example, this activation scheme may provide a technical solution, which may be tailored to the use case, e.g., in terms of cleaning performance, while utilizing a higher power consumption required for this use case.

In another example, controller 202 may be configured to selectively activate both the blower mechanism 215 and the ultrasonic vibration generator 226, e.g., simultaneously, for example, based on identification of a use case, which may require the removal of a relatively large amount of water drops within a relatively short time period, e.g., which may not be efficiently handled by the ultrasonic vibration generator 226 or the blower mechanism 215 when activated separately, and/or based on identification of a use case where a cleaning attempt using one of the ultrasonic vibration generator 226 or the blower mechanism 215 has failed or resulted in only partial cleaning of the surface 220. For example, this activation scheme may provide a technical solution, which may be tailored to the use case, e.g., in terms of cleaning performance, while utilizing a higher power consumption required for this use case.

In some demonstrative aspects, controller 202 may be configured to selectively control a power level at which the blower mechanism 215 is to be activated, for example, based on the use case.

In some demonstrative aspects, controller 202 may be configured to select a power level for the blower mechanism 215, for example, from a plurality of predefined blower power settings, e.g., as described below.

In some demonstrative aspects, controller 202 may be configured to select the power level for the blower mechanism 215, for example, according to an activation scheme, which may be tailored to a use case, e.g., as described below.

In some demonstrative aspects, controller 202 may be configured to select the power level for the blower mechanism 215, for example, according to an activation scheme, which may be configured to provide a technical solution, which may be tailored to the use case, for example, to provide a required cleaning performance for the use case, while reducing, e.g., minimizing, the power consumption and/or the noise level, e.g., as described below.

In some demonstrative aspects, the noise level can be selected, for example, such that the level of noise within a passenger compartment of a particular vehicle model is less than a predetermined threshold. Optionally, the noise level within the passenger compartment can be defined under predefined conditions and/or can be dynamically adjusted according to various conditions, e.g., including conditions outside the compartment, e.g., vehicle speed, type of tires used; and/or conditions within the compartment, e.g., road buzz or ambient noise, music volume level, or the like. Further by way of option, a user can set or modify the noise level that is permitted by the cleaning system, either explicitly, e.g., by setting a value, or implicitly, e.g., by selecting a predefined setting.

In one example, controller 202 may be configured to selectively activate the blower mechanism 215 at a first power level, for example, based on identification of a use case, which may require the removal of a relatively small amount of water drops, e.g., which may be efficiently handled by the blower mechanism 215 at a first power level. For example, this activation scheme may provide a technical solution, which may be tailored to the use case, e.g., in terms of cleaning performance, while utilizing reduced power consumption and generating a reduced level of noise.

In another example, controller 202 may be configured to selectively activate the blower mechanism 215 at a second power level, e.g., higher than the first power level, for example, based on identification of a use case, which may require the removal of a relatively large amount of water drops, e.g., which may not be efficiently handled by the blower mechanism 215 at the first power level, and/or when a characteristic of the blockage is such that the controller 215 is configured to operate at the higher power level. For example, this activation scheme may provide a technical solution, which may be tailored to the use case, e.g., in terms of cleaning performance, while utilizing reduced power consumption and generating a reduced level of noise.

In another example, controller 202 may be configured to selectively activate the blower mechanism 215 at a third power level, e.g., higher than the second power level, for example, based on identification of a use case, which may require the removal of a relatively large amount of water drops, e.g., which may not be efficiently handled by the blower mechanism 215 at the second power level. For example, this activation scheme may provide a technical solution, which may be tailored to the use case, e.g., in terms of cleaning performance, while utilizing the required power consumption for this use case.

In some demonstrative aspects, one or more use cases, e.g., each use case, can be associated with a certain power level or with a plurality of power levels, e.g., depending on additional operational parameters configured in the controller 202. For example, the controller 202 may be configured to start with a first, e.g., lower, power level and increase the power level, e.g., up to some threshold, one or more times, if necessary, e.g., when the initial operation failed to, e.g., substantially completely, remove the blockage.

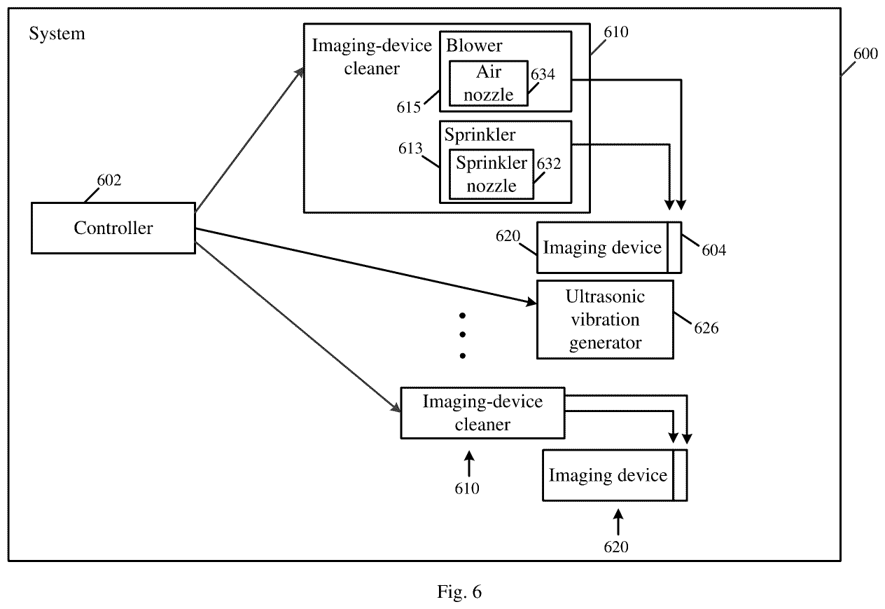

Reference is made to FIG. 6, which schematically illustrates an imaging-device cleaning system 600, in accordance with some demonstrative aspects.

For example, imaging-device cleaning system 200 (FIG. 2) may include one or more components and/or elements of imaging-device cleaning system 600, and/or imaging-device cleaning system 200 (FIG. 2) may be configured to perform one or more operations and/or functionalities of imaging-device cleaning system 600.

In some demonstrative aspects, as shown in FIG. 6, imaging-device cleaning system 600 may include a controller 602 configured to control activation and deactivation of one or more components and/or elements of the imaging-device cleaning system 600, e.g., as described below.

For example, controller 202 (FIG. 2) may include one or more components and/or elements of controller 602, and/or controller 202 (FIG. 2) may be configured to perform one or more operations and/or functionalities of controller 602.

In some demonstrative aspects, controller 602 may include, or may be implemented, partially or entirely, by circuitry and/or logic, e.g., one or more processors including circuitry and/or logic, memory circuitry and/or logic. Additionally or alternatively, one or more functionalities of controller 602 may be implemented by logic, which may be executed by a machine and/or one or more processors, e.g., as described below.

In one example, controller 602 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, as shown in FIG. 6, imaging-device cleaning system 600 may include one or more imaging-device cleaners 610, which may be configured to clean one or more imaging devices 620, e.g., as described below.

For example, imaging-device cleaner 210 (FIG. 2) may include one or more components and/or elements of an imaging-device cleaner 610, and/or imaging-device cleaner 210 (FIG. 2) may be configured to perform one or more operations and/or functionalities of imaging-device cleaner 610.

For example, imaging device 201 (FIG. 2) may include one or more components and/or elements of an imaging devices 620, and/or imaging device 220 (FIG. 2) may be configured to perform one or more operations and/or functionalities of imaging device 620.

In some demonstrative aspects, controller 602 may be configured to control activation of a plurality of imaging-device cleaners 610, for example, to clean a respective plurality of surfaces of a plurality of imaging devices, e.g., as described below.

In some demonstrative aspects, as shown in FIG. 6, an imaging-device cleaner 610 may include a blower 615, e.g., as described below.

For example, blower mechanism 215 (FIG. 2) may include one or more components and/or elements of blower 615, and/or blower mechanism 215 (FIG. 2) may be configured to perform one or more operations and/or functionalities of blower 615.

In some demonstrative aspects, blower 615 may be configured to provide an airflow to be applied onto a surface 604 of an imaging device 620, e.g., as described below.

In some demonstrative aspects, blower 615 may include an air nozzle 634, which may be configured to spread or direct the airflow from the blower 615 onto the surface 604 of the imaging device 620 in a desired manner, e.g., as described below.

In some demonstrative aspects, as shown in FIG. 6, imaging-device cleaner 610 may include a sprinkler 613, e.g., as described below.

For example, sprinkler 213 (FIG. 2) may include one or more components and/or elements of sprinkler 613, and/or sprinkler 213 (FIG. 2) may be configured to perform one or more operations and/or functionalities of sprinkler 613.

In some demonstrative aspects, sprinkler 613 may be configured to sprinkle a liquid onto the surface 604 of the imaging device 620, e.g., as described below.

In some demonstrative aspects, the liquid sprinkled from sprinkler 613 onto the surface 604 may include water, e.g., as described below.

In some demonstrative aspects, the liquid may include an aqueous solution, e.g., as described below.

In other aspects, the liquid sprinkled from sprinkler 613 onto the surface 604 may include any other liquid suitable for cleaning the surface 604 of the imaging device 620.

In some demonstrative aspects, sprinkler 613 may include a sprinkler nozzle 632, which may be configured to spread the liquid from sprinkler 613 onto the surface 604 of the imaging device 620, e.g., as described below.

In some demonstrative aspects, the surface 604 of the imaging device 620 may include a lens surface of a lens of the imaging device 620, e.g., as described below.

In some demonstrative aspects, the surface 604 of the imaging device 620 may include a protective surface, e.g., a radome and/or any other element, which may be configured, for example, to protect the lens of the imaging device 620, e.g., as described below.

In some demonstrative aspects, the surface 604 of the imaging device 620 may include a hydrophobic coating, e.g., hydrophobic coating 224 (FIG. 2), for example, to repel liquid matter, e.g., as described below.

In other aspects, the surface 604 of the imaging device 620 may include any other additional or alternative coating to facilitate cleaning of the surface 604 of imaging device 620.

In some demonstrative aspects, controller 602 may be configured to control activation and deactivation of the blower 615 and the sprinkler 613, e.g., as described below.

In some demonstrative aspects, controller 602 may be configured to control activation of at least one of the blower 615 or the sprinkler 613, for example, based on identification of a predefined blockage scenario in which at least part of a field of view of the imaging device 620, e.g., a field of view of a lens of the imaging device 620, is to be blocked by a substance on the surface 604, e.g., as described below.

In some demonstrative aspects, controller 602 may be configured to control activation and deactivation of the blower 615, e.g., as described below.

In some demonstrative aspects, controller 602 may be configured to control activation of blower 615, for example, based on identification of a predefined blockage scenario in which at least part of the field of view of the imaging device 620, e.g., the field of view of the lens of the imaging device 620, is to be blocked by a substance on the surface 604, e.g., as described below.

In some demonstrative aspects, controller 602 may be configured to control activation and deactivation of the sprinkler 613, e.g., as described below.

In some demonstrative aspects, controller 602 may be configured to control activation of sprinkler 613, for example, based on identification of a predefined blockage scenario in which at least part of the field of view of the imaging device 620, e.g., the field of view of the lens of the imaging device 620, is to be blocked by a substance on the surface 604, e.g., as described below.

In some demonstrative aspects, blower 615 may be controllably operative at a plurality of blower operation modes having a plurality of associated blower noise levels, e.g., as described below.

In some demonstrative aspects, a maximal blower noise level of the blower 615 may be no more than 50 dB.

In some demonstrative aspects, the maximal blower noise level of the blower 615 may be no more than 45 dB.

In other aspects, the maximal blower noise level of the blower 615 may include any other noise level.

In some demonstrative aspects, controller 602 may be configured to control activation of blower 615 at a selected blower operation mode, for example, based on a predefined activation criterion, e.g., as described below.

In some demonstrative aspects, the predefined activation criterion may be based on a blower noise level associated with the selected blower operation mode, e.g., as described below.

In some demonstrative aspects, the predefined activation criterion may be based on one or more blockage attributes of the predefined blockage scenario, e.g., as described below.

In other aspects, the predefined activation criterion may be based on any other additional or alternative attributes.

In some demonstrative aspects, controller 602 may be configured to determine an activation setting for controlling activation of blower 615 and/or sprinkler 613, e.g., as described below.

In some demonstrative aspects, controller 602 may be configured to determine the activation setting, for example, based on the predefined blockage scenario, e.g., as described below.

In other aspects, controller 602 may be configured to determine the activation setting based on any other additional or alternative criteria.

In some demonstrative aspects, controller 602 may be configured to control activation of at least one of the blower 615 and/or the sprinkler 613, for example, according to the activation setting, e.g., as described below.

In some demonstrative aspects, controller 602 may be configured to control activation of the blower 615, for example, according to the activation setting, e.g., as described below.

demonstrative aspects, controller 602 may be configured to control activation of the sprinkler 613, for example, according to the activation setting, e.g., as described below.

In some demonstrative aspects, the activation setting may be configured to define a cleaning procedure, for example, to remove the substance from the surface 604 of the imaging device 620, e.g., as described below.

In some demonstrative aspects, the activation setting may be configured to define whether or not the blower 615 is to be activated, e.g., as described below.

In some demonstrative aspects, the activation setting may be configured to define whether or not the sprinkler 613 is to be activated, e.g., as described below.

In some demonstrative aspects, the activation setting may be configured to define an operation mode at which at least one of the blower 615 and/or the sprinkler 613 is to be activated, e.g., as described below.

In some demonstrative aspects, the activation setting may be configured to define an operation mode at which the blower 615 is to be activated, e.g., as described below.

In some demonstrative aspects, the activation setting may be configured to define an operation mode at which the sprinkler 613 is to be activated, e.g., as described below.

In some demonstrative aspects, the activation setting may be configured to define an operation mode at which both the blower 615 and the sprinkler 613 are to be activated, e.g., as described below.

In some demonstrative aspects, the activation setting may be configured to define an activation time duration at which at least one of the blower 615 and/or the sprinkler 613 is to be active, e.g., as described below.

In some demonstrative aspects, the activation setting may be configured to define an activation time duration at which the blower 615 is to be active, e.g., as described below.

In some demonstrative aspects, the activation setting may be configured to define an activation time duration at which the sprinkler 613 is to be active, e.g., as described below.

In some demonstrative aspects, the activation setting may be configured to define an activation time duration at which both the blower 615 and the sprinkler 613 are to be active, e.g., as described below.

In some demonstrative aspects, the activation setting may be based on a type of a substance on the surface 604 of the imaging device 620, e.g., as described below.

In some demonstrative aspects, the activation setting may be based on an amount of the substance on the surface 604 of the imaging device 620, e.g., as described below.

In some demonstrative aspects, the activation setting may be based on a location of the substance on the surface 604 of the imaging device 620, e.g., as described below.

In some demonstrative aspects, the activation setting may be based on a percentage of the field of view blocked by the substance on the surface 604 of the imaging device 620, e.g., as described below.

In other aspects, activation setting may be based on any other additional or alternative attribute of the substance on the surface 604 of the imaging device 620.

In some demonstrative aspects, the activation setting may be based on a real-time driving scenario of a vehicle including the imaging device 620, for example, vehicle 100 (FIG. 1), e.g., as described below.

In some demonstrative aspects, the activation setting may be configured to define an activation cycle, e.g., as described below.

In some demonstrative aspects, the activation cycle may include activation of the sprinkler 613 followed by activation of the blower 615, e.g., as described below.

In other aspects, any other activation cycle may be utilized.

In some demonstrative aspects, controller 602 may be configured to repeat activation of the sprinkler 613 and/or the blower 615 for a plurality of activation cycles, for example, until identification that a cleaning criterion is met, e.g., as described below.

In some demonstrative aspects, controller 602 may be configured to determine the activation setting to activate only the blower 615, for example, based on a determination that the predefined blockage scenario includes a water-spot scenario, in which the substance on the surface 604 includes spots of water, and/or based on identification of any other suitable predefined blockage scenario, e.g., as described below.

In some demonstrative aspects, controller 602 may be configured to determine the activation setting to activate the sprinkler 613 for a first time period and to activate the blower 615 for a second time period after an end of the first time period, for example, based on a determination that the predefined blockage scenario includes a solid-substance scenario, in which the substance on the surface 604 includes a solid substance, and/or based on identification of any other suitable predefined blockage scenario, e.g., as described below.

In some demonstrative aspects, controller 602 may be configured to determine the activation setting to activate the sprinkler 613 and the blower 615 simultaneously, for example, based on a determination that the predefined blockage scenario includes a mixed-substance scenario, in which the substance on the surface 604 includes a mixture of water and a solid substance, and/or based on identification of any other suitable predefined blockage scenario, e.g., as described below.

In some demonstrative aspects, controller 602 may be configured to activate the blower 615 to provide the airflow at a sufficient velocity, for example, such that the airflow is to be provided onto the surface 604 of the imaging device 620 with a velocity of at least 30 meters per second (m/s), e.g., as described below.

In other aspects, controller 602 may be configured to activate the blower 615 to provide the airflow onto the surface 604 of the imaging device 620 with any other suitable velocity.

In some demonstrative aspects, controller 602 may be configured to activate the blower 615 at a blower power level, which may be based, for example, on the predefined blockage scenario, e.g., as described below.

In some demonstrative aspects, controller 602 may be configured to activate the blower 615 at a first blower power level, for example, based on identification of a first predefined blockage scenario, e.g., as described below.

In some demonstrative aspects, controller 602 may be configured to activate the blower 615 at a second blower power level, different from the first power level, for example, based on identification of a second predefined blockage scenario different from the first predefined blockage scenario, e.g., as described below.

In some demonstrative aspects, controller 602 may be configured to control activation and deactivation of an ultrasonic vibration generator 626, e.g., as described below.

For example, ultrasonic vibration generator 226 (FIG. 2) may include one or more components and/or elements of ultrasonic vibration generator 626, and/or ultrasonic vibration generator 226 (FIG. 2) may be configured to perform one or more operations and/or functionalities of ultrasonic vibration generator 626.

In some demonstrative aspects, controller 602 may be configured to activate the ultrasonic vibration generator 626, for example, to generate vibrations to at least partially remove a substance on the surface 604 of the imaging device 620, e.g., as described below.

In some demonstrative aspects, controller 602 may be configured to activate the ultrasonic vibration generator 626, for example, to generate vibrations to at least partially remove drops of the liquid from the surface 604 of the imaging device 620, e.g., as described below.

In some demonstrative aspects, controller 602 may be configured to set the ultrasonic vibration generator 626 to generate the vibrations at a vibration frequency, which may be based, for example, on the predefined blockage scenario, e.g., as described below.

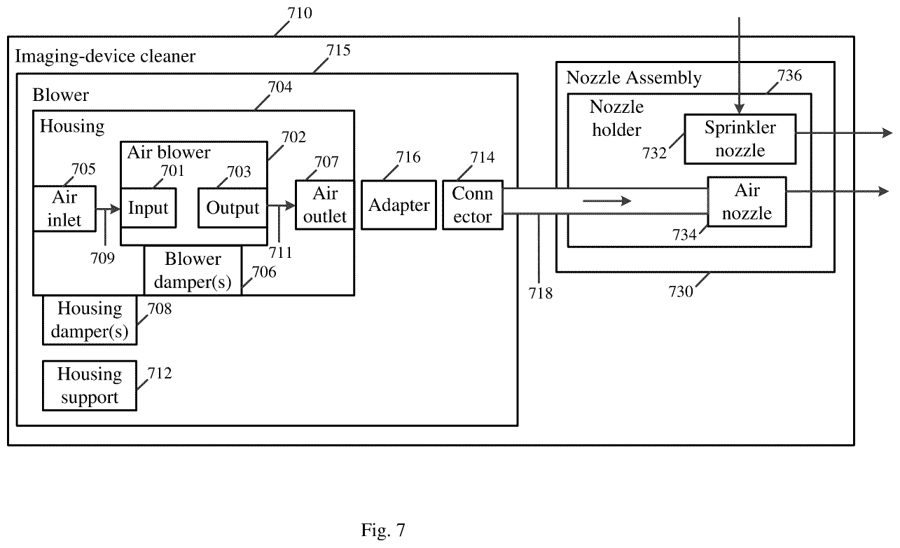

Reference is made to FIG. 7, which schematically illustrates an imaging-device cleaner 710, in accordance with some demonstrative aspects.

For example, imaging-device cleaner 610 (FIG. 6) may include one or more components and/or elements of imaging-device cleaner 710, and/or imaging-device cleaner 610 (FIG. 6) may be configured to perform one or more operations and/or functionalities of imaging-device cleaner 710.

In some demonstrative aspects, as shown in FIG. 7, imaging-device cleaner 710 may include a blower 715, which may be configured to provide an airflow to be applied onto a surface of an imaging device, e.g., surface 604 (FIG. 6) of imaging device 620 (FIG. 6).

For example, blower 615 (FIG. 6) may include one or more components and/or elements of blower 715, and/or blower 615 (FIG. 6) may be configured to perform one or more operations and/or functionalities of blower 715.

In some demonstrative aspects, as shown in FIG. 7, blower 715 may include an air blower 702, e.g., as described below.

In some demonstrative aspects, as shown in FIG. 7, air blower 702 may include a blower input 701 and a blower output 703, e.g., as described below.

In some demonstrative aspects, as shown in FIG. 7, blower 715 may include a housing 704 configured to enclose the air blower 702, e.g., as described below.

In some demonstrative aspects, housing 704 may include a noise absorbing material, e.g., to absorb noise caused by the air blower 702, e.g., as described below.

In some demonstrative aspects, as shown in FIG. 7, housing 704 may include an air inlet 705, e.g., as described below.

In some demonstrative aspects, as shown in FIG. 7, housing 704 may include an air outlet 707, e.g., as described below.

In some demonstrative aspects, as shown in FIG. 7, housing 704 may include an inlet path 709, for example, to provide air from the air inlet 705 to the blower input 701, e.g., as described below.

In some demonstrative aspects, as shown in FIG. 7, housing 704 may include an outlet path 711, for example, to provide the airflow from the blower output 703 to the air outlet 707, e.g., as described below.

In some demonstrative aspects, at least part of the inlet path 709 may include a noise-absorbing path configured to absorb noise generated by the air blower 702, e.g., as described below.

In some demonstrative aspects, the noise-absorbing path may include a labyrinth-like path including one or more turns, e.g., as described below.

In some demonstrative aspects, the noise-absorbing path may be at least partially covered by a noise absorbing material, e.g., as described below.

In some demonstrative aspects, the noise absorbing material may include Polyurethane, e.g., as described below.

In other aspects, the noise absorbing material of the noise-absorbing path may include any other additional or alternative type of material configured to absorb noise.

In some demonstrative aspects, as shown in FIG. 7, blower 715 may include one or more blower dampers 706 connected, for example, between the air blower 702 and the housing 704, e.g., as described below.

In some demonstrative aspects, the one or more blower dampers 706 may be configured to dampen vibrations from the air blower 702, e.g., as described below.

In some demonstrative aspects, as shown in FIG. 7, blower 715 may include one or more housing dampers 708, for example, to connect the housing 704 to a housing support 712, e.g., as described below.

In some demonstrative aspects, the one or more housing dampers 708 may be configured to dampen vibrations from the housing 704, e.g., as described below.

In some demonstrative aspects, imaging-device cleaner 710 may include a pipe 718, which may be configured to guide an airflow from the blower 715 towards an air nozzle 734, e.g., as described below.

In some demonstrative aspects, the pipe 718 may be formed of a material having a relatively low friction coefficient, which may be suitable for guiding the airflow from the blower 715 with reduced, e.g., minimal, loss, e.g., as described below.

In some demonstrative aspects, an inner surface of the pipe 718 may have a friction coefficient of less than 0.6.

In some demonstrative aspects, the inner surface of the pipe 718 may have a friction coefficient in a range of 0.2-0.5.

In other aspects, the inner surface of the pipe 718 may have any other suitable friction coefficient.

In some demonstrative aspects, imaging-device cleaner 710 may include a connector 714 configured to fluidly connect between the air outlet 707 and the pipe 718, for example, to guide the airflow, which is to be applied onto a surface 604 (FIG. 6) of imaging device 620 (FIG. 6), e.g., as described below.

In some demonstrative aspects, the connector 714 may be configured to mitigate noise from the air outlet 707, e.g., as described below.

In some demonstrative aspects, the connector 714 may include a plurality of inner fitting grippers (not shown in FIG. 7), which may be configured to maintain a tight fit between the connector 714 and the air outlet 707, e.g., as described below.

In some demonstrative aspects, the inner fitting grippers may be configured to mitigate the noise from the air outlet 707, e.g., as described below.

In some demonstrative aspects, imaging-device cleaner 710 may include an adapter 716 to fluidically connect the air outlet 707 to an air-conveyor, which is to convey the airflow towards the surface 604 (FIG. 6) of the imaging device 620 (FIG. 6), e.g., as described below.

In one example, the air-conveyor may include connector 714, for example, in case imaging-device cleaner 710 implements the connector 714, e.g., as described below.

In another example, the air-conveyor may include pipe 718, for example, in case imaging-device cleaner 710 implements pipe 718, e.g., without implementation of the connector 714.

In another example, the air-conveyor may include air nozzle 734, for example, in case the air-nozzle 734 is to be connected directly to the adapter 716, e.g., without implementation of the connector 714 and the pipe 718.

In other aspects, the air-conveyor may include any other suitable element to convey the airflow from the blower 715.

In some demonstrative aspects, the adapter 716 may be configured to convey the airflow via a generally monotonous transition between the air outlet 707 and the air-conveyor, e.g., as described below.

In some demonstrative aspects, imaging-device cleaner 710 may include a nozzle assembly 713, e.g., as described below.

In some demonstrative aspects, nozzle assembly 713 may include a sprinkler nozzle 732, e.g., sprinkler nozzle 632 (FIG. 6), which may be configured to spread a liquid from sprinkler 613 (FIG. 6) onto the surface 604 (FIG. 6) of the imaging device 620 (FIG. 6), e.g., as described below.

In some demonstrative aspects, the sprinkler nozzle 732 may be configured to spread the liquid at a predefined sprinkling direction onto the surface 604 (FIG. 6) of the imaging device 620 (FIG. 6), e.g., as described below.

For example, sprinkler 613 (FIG. 6) may include one or more components and/or elements of sprinkler nozzle 732.

In some demonstrative aspects, nozzle assembly 713 may include an air nozzle 734, e.g., air nozzle 634 (FIG. 6), which may be configured to spread the airflow from blower 715 onto the surface 604 (FIG. 6) of the imaging device 620 (FIG. 6), e.g., as described below.

In some demonstrative aspects, air nozzle 734 may be configured to spread the airflow from blower 715 at a predefined airflow direction onto the surface 604 (FIG. 6) of the imaging device 620 (FIG. 6), e.g., as described below.

In some demonstrative aspects, the predefined airflow direction may be substantially identical to the predefined sprinkling direction, e.g., as described below.

In some demonstrative aspects, the predefined airflow direction may be within a range of no more than 10 degrees of the predefined sprinkling direction, e.g., as described below.

In other aspects, any other suitable predefined airflow direction and/or predefined sprinkling direction may be implemented.

In some demonstrative aspects, nozzle assembly 713 may include a nozzle holder 736, which may be configured to hold the sprinkler nozzle 732 and the air nozzle 734, e.g., as described below.

In some demonstrative aspects, the nozzle holder 736 may be configured to maintain a predefined relative positioning between the air nozzle 734 and the sprinkler nozzle 732, e.g., as described below.

In some demonstrative aspects, the nozzle holder 736 may be configured to maintain the air nozzle 734, for example, above the surface 604 (FIG. 6) of the imaging device 620 (FIG. 6), e.g., as described below.

In some demonstrative aspects, the nozzle holder 736 may be configured to maintain the sprinkler nozzle 732, for example, above the air nozzle 734, e.g., as described below.

In some demonstrative aspects, the nozzle holder 736 may be configured to maintain the air nozzle 734 and the sprinkler nozzle 732 outside at least 70 percent of the field of view of the imaging device 620 (FIG. 6), e.g., as described below.

In some demonstrative aspects, the nozzle holder 736 may be configured to maintain the air nozzle 734 and the sprinkler nozzle 732 outside at least 80 percent of the field of view of the imaging device 620 (FIG. 6), e.g., as described below.

In some demonstrative aspects, the nozzle holder 736 may be configured to maintain the air nozzle 734 and the sprinkler nozzle 732 outside at least 90 percent of the field of view of the imaging device 620 (FIG. 6), e.g., as described below.

In some demonstrative aspects, the predefined relative positioning between the air nozzle 734 and the sprinkler nozzle 732 may be configured, for example, such that, when the blower 715 is activated simultaneously with the sprinkler 613 (FIG. 6), the airflow provided by the blower 715 is to increase a velocity of the liquid from the sprinkler nozzle 732 towards the surface 604 (FIG. 6).

In some demonstrative aspects, the nozzle holder 736 may be configured to position a nozzle output of the air nozzle 734, for example, in proximity to a perimeter of the surface 604 (FIG. 6) of the imaging device 620 (FIG. 6) and above the surface 604 (FIG. 6) of the imaging device 620 (FIG. 6), for example, such that the nozzle output of the air nozzle 734 is to spread the airflow onto substantially an entirety of the surface 604 (FIG. 6) of the imaging device 620 (FIG. 6), e.g., as described below.

In some demonstrative aspects, the nozzle output of the air nozzle 734 may be configured to substantially uniformly distribute the airflow on substantially the entirety of the surface 604 (FIG. 6) of the imaging device 620 (FIG. 6), e.g., as described below.

In some demonstrative aspects, a width of the nozzle output of the air nozzle 734 may be wider than a width of the surface 604 (FIG. 6) of the imaging device 620 (FIG. 6), e.g., as described below.

In some demonstrative aspects, a difference between the width of the nozzle output of the air nozzle 734 and the width of the surface 604 (FIG. 6) of the imaging device 620 (FIG. 6) may be in a range between 0.5 millimeter (mm) and 1 mm, e.g., as described below.

In other aspects, any other suitable difference between the width of the nozzle output of the air nozzle 734 and the width of the surface 604 (FIG. 6) of the imaging device 620 (FIG. 6) may be implemented.

In some demonstrative aspects, a shape of the nozzle output of the air nozzle 734 may be configured to conform to a shape of a perimeter of the surface 604 (FIG. 6) of the imaging device 620 (FIG. 6), e.g., as described below.

In other aspects, the nozzle output of the air nozzle 734 may have any other suitable configuration.

In some demonstrative aspects, the air nozzle 734 may include an air path, which may be configured to gradually and monotonously transition between a cross section of a nozzle input of the air nozzle 734 and a cross section of the nozzle output of the air nozzle 734, e.g., as described below.

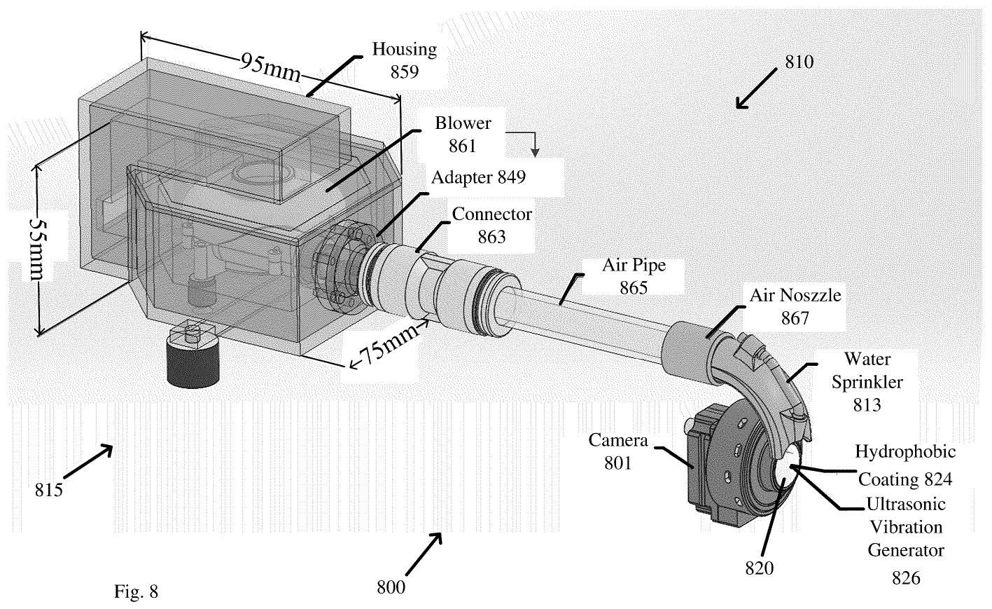

Reference is made to FIG. 8, which schematically illustrates imaging-device cleaning system 800, in accordance with some demonstrative aspects.

For example, imaging-device cleaning system 600 (FIG. 6) may include one or more components and/or elements of imaging-device cleaning system 800, and/or imaging-device cleaning system 600 (FIG. 6) may be configured to perform one or more operations and/or functionalities of imaging-device cleaning system 800.

In some demonstrative aspects, as shown in FIG. 8, imaging-device cleaning system 800 may include an imaging-device cleaner 810, which may be configured to clean a lens 820 of a camera 801, e.g., as described below. For example, imaging device 620 (FIG. 6) may include camera 801, and surface 604 (FIG. 6) may include lens 820.

For example, imaging-device cleaner 610 (FIG. 6) may include one or more components and/or elements of imaging-device cleaner 810, and/or imaging-device cleaner 610 (FIG. 2) may be configured to perform one or more operations and/or functionalities of imaging-device cleaner 810.

In some demonstrative aspects, as shown in FIG. 8, imaging-device cleaner 810 may include a blower mechanism 815, and a water sprinkler 813, e.g., as described below.

For example, blower 615 (FIG. 6) may include one or more components and/or elements of blower mechanism 815, and/or blower 615 (FIG. 6) may be configured to perform one or more operations and/or functionalities of blower mechanism 815.

For example, sprinkler 613 (FIG. 6) may include one or more components and/or elements of water sprinkler 813, and/or sprinkler 613 (FIG. 6) may be configured to perform one or more operations and/or functionalities of water sprinkler 813.

In some demonstrative aspects, as shown in FIG. 8, imaging-device cleaning system 800 may include a hydrophobic coating 824, which may be configured to repel liquid matter, e.g., water, from the lens 820 of camera 801, e.g., as described below.

For example, hydrophobic coating 224 (FIG. 2) may include one or more components and/or elements of hydrophobic coating 824, and/or hydrophobic coating 224 (FIG. 2) may be configured to perform one or more operations and/or functionalities of water hydrophobic coating 824.

In some demonstrative aspects, as shown in FIG. 8, imaging-device cleaning system 800 may include an ultrasonic vibration generator 826, which may be configured to remove by vibrations foreign matter from the lens 820 of the camera 801, e.g., as described below.

For example, ultrasonic vibration generator 626 (FIG. 6) may include one or more components and/or elements of ultrasonic vibration generator 826, and/or ultrasonic vibration generator 626 (FIG. 6) may be configured to perform one or more operations and/or functionalities of ultrasonic vibration generator 826.

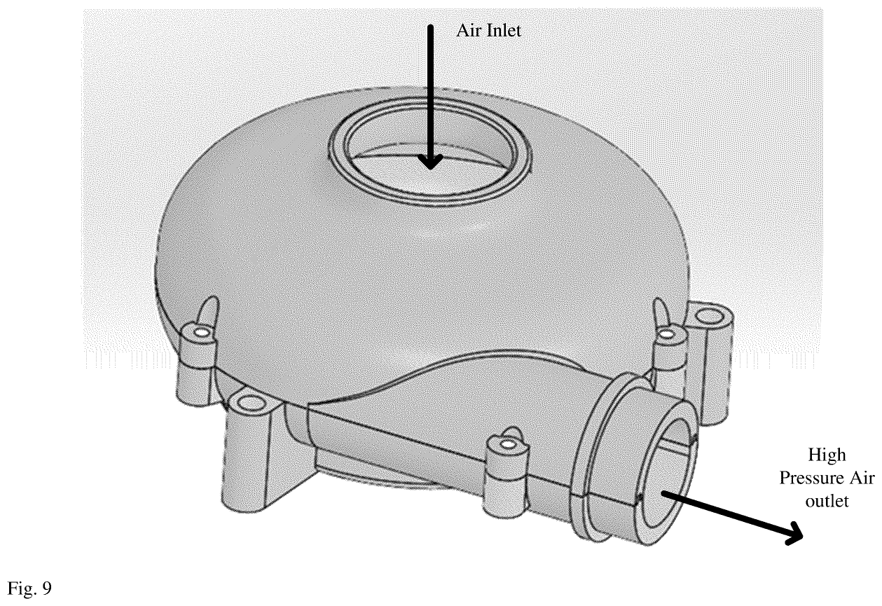

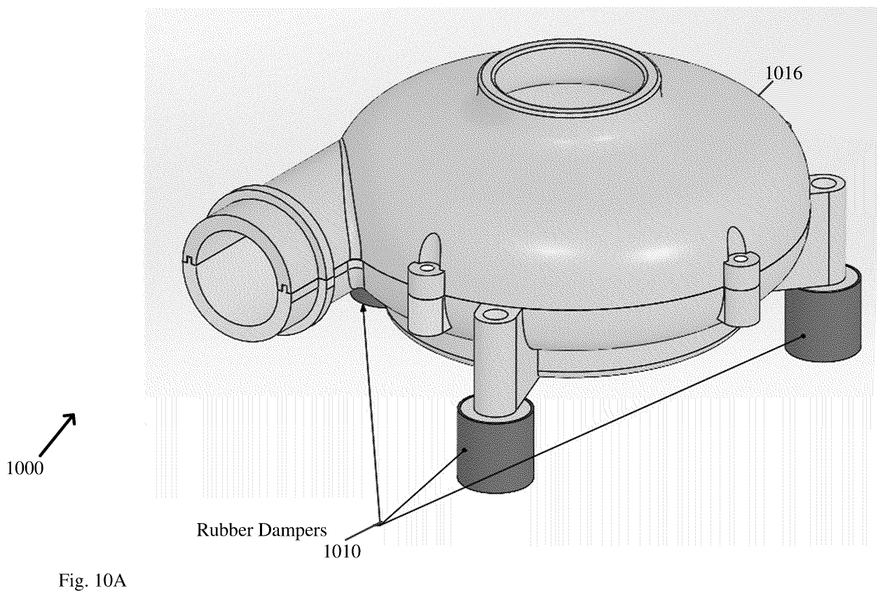

In some demonstrative aspects, as shown in FIG. 8, blower mechanism 815 may include a blower 861, which may be configured to generate a relatively “strong” flow of high-pressure airflow, e.g., having a relatively high air velocity, e.g., as shown in FIG. 9.

In some demonstrative aspects, blower 861 may be designed, for example, while taking into consideration a plurality of technical characteristics, which may be related to the technical implementation of the blower 861 for cleaning the lens 820 of camera 801 in a vehicle, e.g., as described below.

In some demonstrative aspects, blower 861 may be designed, for example, while taking into consideration airflow characteristics, e.g., pressure, velocity and/or flow rate, for example, to provide a technical solution to support cleaning the lens 820 of camera 801, e.g., as described below.

In some demonstrative aspects, the airflow characteristics of the blower 861 may be related to, or affected by, environmental conditions. For example, blower 861 may be designed to provide a technical solution to support airflow characteristic settings, e.g., pressure, velocity and/or flow rate, which may be suitable for a predefined range of environmental conditions, e.g., temperature, humidity, barometric pressure, or the like.

In some demonstrative aspects, blower 861 may be designed, for example, while taking into consideration a power consumption characteristic. For example, the technical implementation of the blower 861 for cleaning the lens 820 of camera 801 in a vehicle may impose power consumption limitations, for example, due to limited availability of electric power.

In some demonstrative aspects, blower 861 may be designed, for example, while taking into consideration a noise characteristic. For example, the technical implementation of the blower 861 for cleaning the lens 820 of camera 801 in a vehicle may impose noise level limitations, for example, according to levels defined by vehicle manufacturers and/or standards.

In some demonstrative aspects, blower 861 may be designed, for example, while taking into consideration dimension characteristics. For example, the technical implementation of the blower 861 for cleaning the lens 820 of camera 801 in a vehicle may impose dimension limitations, for example, due to limited space available for installation of the blower 861 at one or more particular locations of the vehicle.

In some demonstrative aspects, blower 861 may be designed, for example, while taking into consideration a life expectancy characteristic. For example, the technical implementation of the blower 861 for cleaning the lens 820 of camera 801 in a vehicle may impose life expectancy limitations, for example, according to maintenance intervals defined by vehicle manufacturers and/or standards.

In some demonstrative aspects, blower 861 may be configured to generate the high-pressure airflow with a pressure and a velocity, which may be sufficient to clean the lens 820 of camera 801.

In some demonstrative aspects, blower 861 may be configured to have relatively small dimensions, e.g., dimensions of about 50×60×30 millimeter (mm) or any other suitable dimensions.

In some demonstrative aspects, blower 861 may be configured to operate at one or more power modes, for example, within a predefined range of powers, e.g., in a range between 5-12 Watt (W), or any other suitable power range.

In some demonstrative aspects, blower 861 may be configured to operate with a relatively low level of noise, for example, a noise level below 65 dB, for example, a noise level below 60 dB, e.g., a noise level in the range of 53-58 dB, or any other suitable noise levels.

In some demonstrative aspects, blower 861 may be configured based on a trade-off between air-flow characteristics and power consumption and/or noise characteristics.

For example, blower 861 may be configured to provide an airflow, which may be strong enough, e.g., in terms of pressure, velocity and/or flow rate, to clean the lens 820 of the camera 801 at one or more predefined use cases.

In some demonstrative aspects, blower 861 may be controlled, e.g., by controller 602 (FIG. 6), to operate at a power mode, which may be sufficient to provide an airflow, which may be strong enough, e.g., in terms of pressure, velocity and/or flow rate, to clean the lens 820 of the camera 801 at a particular use case, for example, while maintaining a relatively low power level, e.g., as may be possible.

In one example, blower 861 may be operable at a first power mode, e.g., a 5 W power mode, to provide an airflow, which may be strong enough, e.g., in terms of pressure, velocity and/or flow rate, to clean the lens 820 of the camera 801 at a first predefined use case, e.g., which may require a relatively weaker airflow.

In another example, blower 861 may be operable at a second power mode, e.g., a 7 W power mode, to provide an airflow, which may be strong enough, e.g., in terms of pressure, velocity and/or flow rate, to clean the lens 820 of the camera 801 at a second predefined use case, e.g., which may require a slightly stronger airflow.

In another example, blower 861 may be operable at a third power mode, e.g., a 10 W power mode, to provide an airflow, which may be strong enough, e.g., in terms of pressure, velocity and/or flow rate, to clean the lens 820 of the camera 801 at a third predefined use case, e.g., which may require a stronger airflow.

In another example, blower 861 may be operable at a fourth power mode, e.g., a 12 W power mode, to provide an airflow, which may be strong enough, e.g., in terms of pressure, velocity and/or flow rate, to clean the lens 820 of the camera 801 at a fourth predefined use case, e.g., which may require a very strong airflow.

In some demonstrative aspects, blower mechanism 815 may be configured to implement one or more noise reduction mechanisms to reduce a noise level during operation of the blower 861, e.g., as described below.

In some demonstrative aspects, blower mechanism 815 may be configured to reduce the noise level to below 55 dB, for example, below 50 dB, e.g., to a noise level of about 45 dB or lower, or any other suitable noise level.

In some demonstrative aspects, as shown in FIG. 8, blower mechanism 815 may include a housing 859, which may be configured to house the blower 861.

For example, housing 704 (FIG. 7) may include one or more components and/or elements of housing 859, and/or housing 704 (FIG. 7) may be configured to perform one or more operations and/or functionalities of housing 859.

In some demonstrative aspects, housing 859 may be configured to dampen noise caused by the blower 861, e.g., as described below.

In some demonstrative aspects, the housing 859 may be configured according to certain characteristics of the intended use profile and the environment in which the blower 861 is intended to be used, for example, in particular for cleaning cameras and related optical elements of an imaging device used onboard a vehicle for vehicle safety systems used by such vehicles.

In some demonstrative aspects, housing 859 may be configured to dampen noise from the blower 861, for example, with reduced, e.g., minimal or optimized, effect on the airflow characteristics, e.g., at the air outlet of blower 861.

In some demonstrative aspects, blower mechanism 815 may include a single housing 859 enclosing the blower 861. In other aspects, blower mechanism 815 may include a plurality of housings 859 enclosing the blower 861, e.g., according to a babushka-like packaging.

In some demonstrative aspects, housing 859 may be configured to dampen noise from the blower 861, for example, absorbing vibrations and/or soundwaves emanating from the air inlet of blower 861, the air outlet of blower 861, and/or the body of the blower 861, e.g., as described below.

In some demonstrative aspects, housing 859 may be configured to dampen noise from the blower 861, for example, breaking vibrations and/or soundwaves emanating from the air inlet of blower 861, the air outlet of blower 861, and/or the body of the blower 861, e.g., as described below.

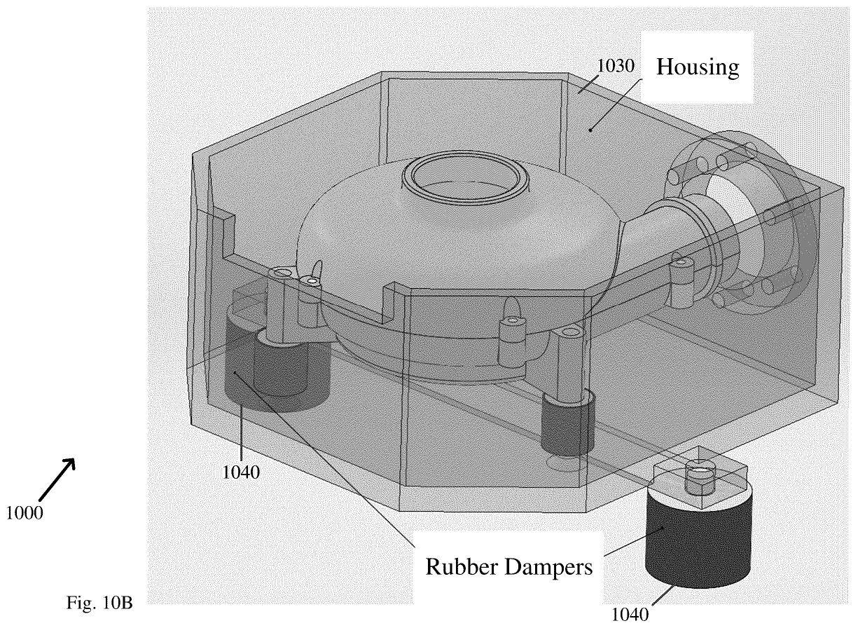

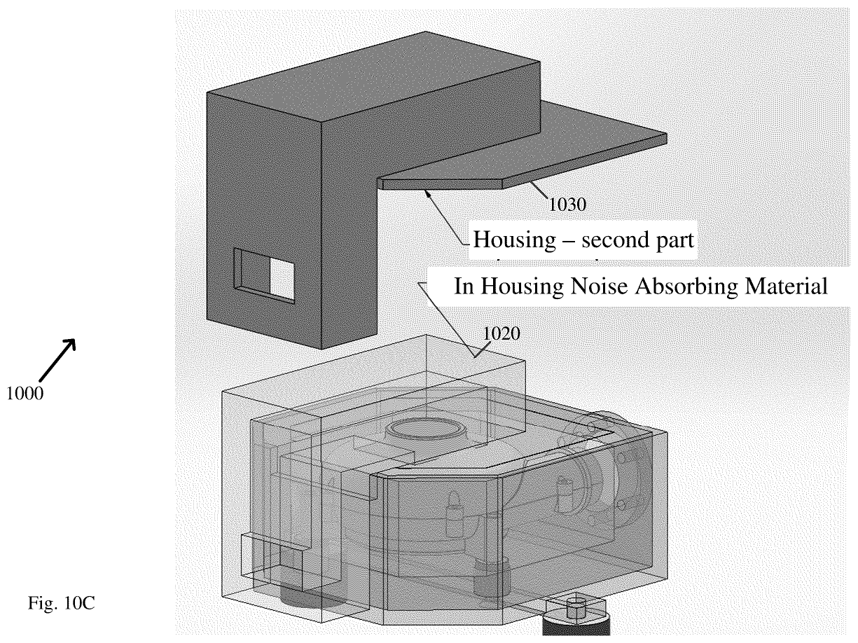

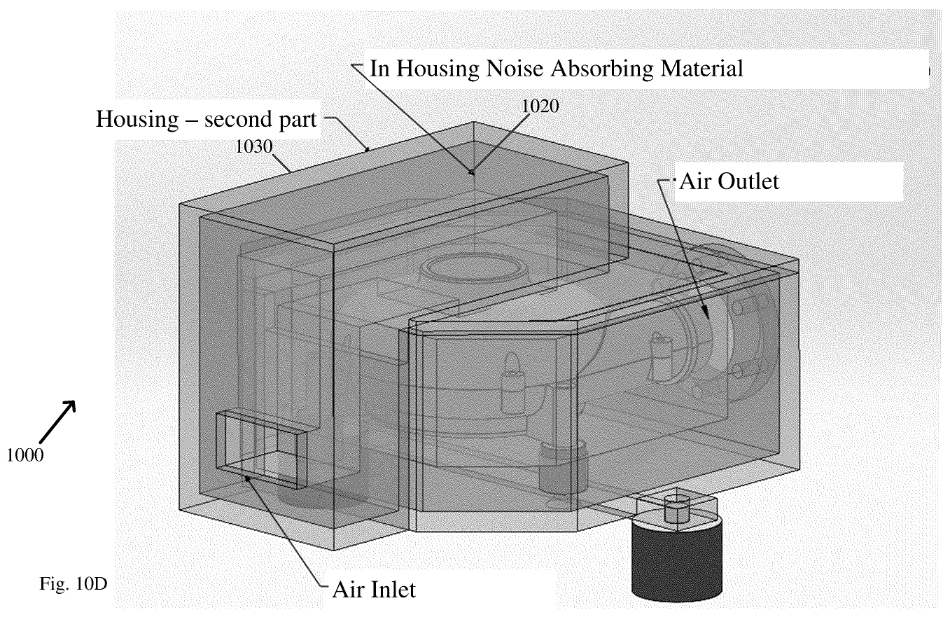

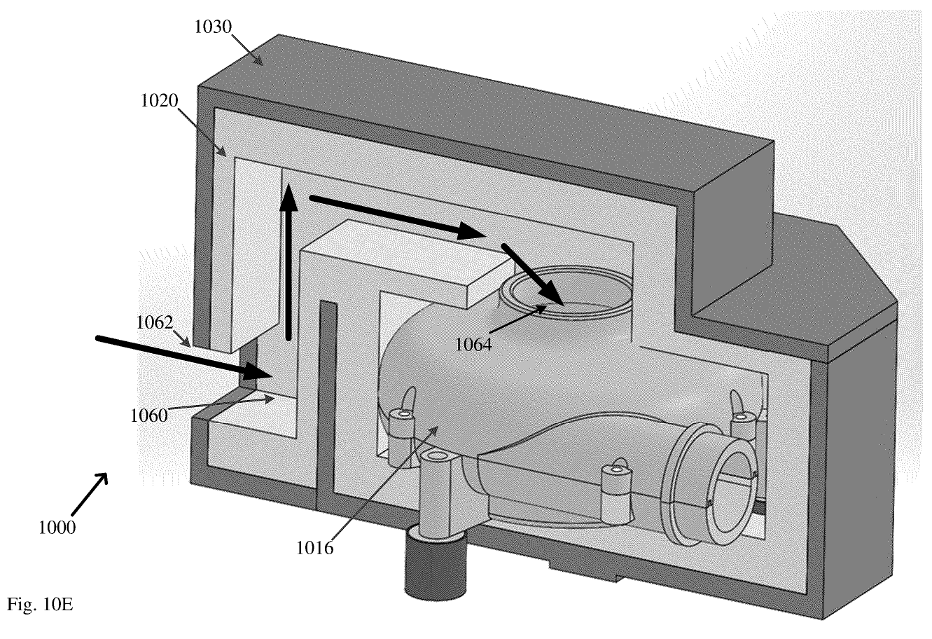

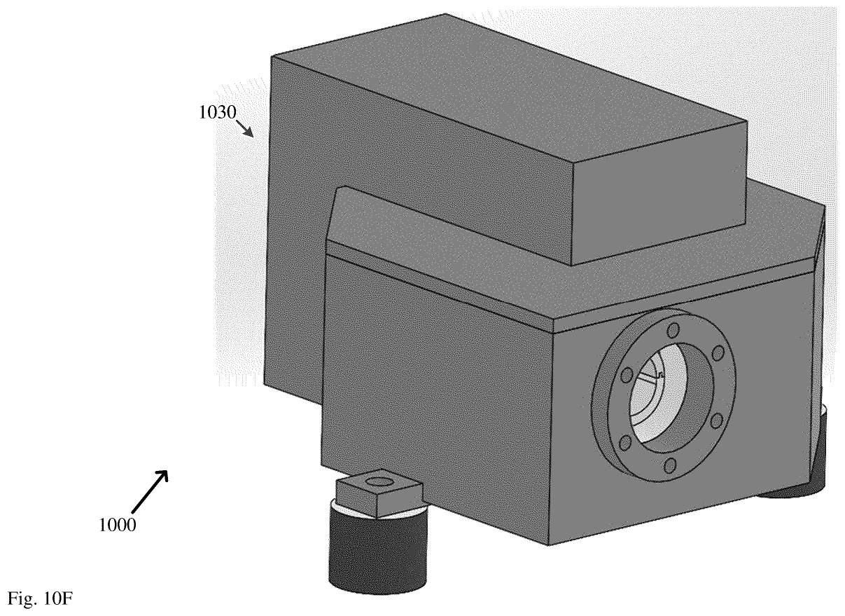

Reference is made to FIGS. 10A, 10B, 10C, 10D, which schematically illustrate components of a blower assembly 1000, in accordance with some demonstrative aspects.

For example, blower mechanism 815 (FIG. 8) may include one or more components and/or elements of blower assembly 1000, and/or blower mechanism 815 (FIG. 8) may be configured to perform one or more operations and/or functionalities of blower assembly 1000.

In some demonstrative aspects, as shown in FIG. 10A, the blower assembly 1000 may include a first set of dampers, e.g., rubber dampers 1010, which may be attached to a blower 1016, for example, to dampen vibrations of the blower 1016.

In one example, as shown in FIG. 10A, the blower assembly 1000 may include three rubber dumpers 1010 attached to the blower 1016. In other aspects, any other type and/or number of dampers 1010 may be utilized.

In some demonstrative aspects, as shown in FIGS. 10C and 10D, the blower assembly 1000 may include a noise absorbing material 1020, which may be placed around the body of the blower 1016, e.g., to absorb noise caused by the blower 1016.

In one example, the noise absorbing material 1020 may include a noise absorbing sponge, a noise absorbing foam, and/or any other suitable noise absorbing material.

In one example, the noise absorbing material 1020 may have a thickness of about 3.65 mm. In other aspects, any other thickness may be implemented.

In some demonstrative aspects, as shown in FIGS. 10B, 10C and 10D, the blower assembly 1000 may include a housing 1030, e.g., a sealed housing, which may be configured to enclose the blower 1016 and the noise absorbing material 1020.

In one example, the housing 1030 may be formed by printed nylon, e.g., with a thickness of about 3 mm. In other aspects, the housing 1030 may be formed of any other suitable materials.

In some demonstrative aspects, as shown in FIG. 10B, the blower assembly 1000 may include a second set of dampers, e.g., rubber dampers 1040, which may be attached to the housing 1030, for example, to dampen vibrations of the housing 1030.

In some demonstrative aspects, the blower assembly 1000 may include at least one more additional noise-absorbing housing structures, e.g., each including a housing and a noise absorbing material, which may enclose the housing, e.g., in a babushka-like package.

In some demonstrative aspects, the noise absorbing material 1020 may be configured to provide a technical solution to dampen noise by “breaking” noise soundwaves, e.g., as described below.

Reference is also made to FIGS. 10E, which schematically illustrates a cross-section of the blower assembly 1000, and to FIG. 10F, which schematically illustrates an external view of the housing 1030 of the blower assembly 1000, in accordance with some demonstrative aspects.

In some demonstrative aspects, as shown in FIG. 10E, the noise absorbing material 1020 may be designed to form a duct 1060 between an air inlet 1062 of the blower assembly 1000 and an air inlet 1064 of the blower 1016.

In some demonstrative aspects, a size and/or shape of a cross-section the duct 1060 may be based on a size and/or shape of an air inlet 1064 of the blower 1016.

For example, a cross-section area of the duct 1060, e.g., along the path of the duct 1060, may be configured to be substantially equal to or greater than a cross-section area of the air inlet 1064 of the blower 1016.

In some demonstrative aspects, as shown in FIG. 10E, the duct 1060 may be configured to have a labyrinth shape, for example, including a plurality of sharp turns, e.g., 90-degree turns and/or any other turns.

For example, the labyrinth-shaped duct 1060 may be implemented to provide a technical solution to support improved noise mitigation, for example, by using the sharp turns to cause the noise soundwaves to lose energy or change frequency when impacting (“crashing into”) the sidewalls of the duct 1060.

In some demonstrative aspects, the labyrinth shape of the duct 1060 may be designed while taking into consideration an effect of the labyrinth shape on the airflow via the duct 1060. For example, too many sharp turns and/or turns which are too-sharp may result in a turbulent airflow, which may result in a reduced flow rate and/or reduced pressure.

In some demonstrative aspects, a design of the duct 1060 may be optimized for use with cameras installed onboard a vehicle and the functionality of the blower 1016.

For example, an intake portion, e.g., from the inlet 1062 of the housing 1030 to the inlet 1064 of the blower 1016, may be designed to have turns, and can be positioned strategically within the vehicle structure to reduce noise as much as possible.

For example, an outtake portion, e.g., from an outlet of the blower 1016 to an outlet of the housing 1030, may be designed to be relatively straight, for example, to maintain as much throughput as possible, and to support the location of the air nozzle, e.g., air nozzle 734 (FIG. 7), which may not be as flexible, e.g., as it should be adjacent to the lens and is some cases may be quite close to a position of a driver's or passenger's head.

In some use cases, a design may sacrifice some efficiency (e.g., by having sound breaking turns) in certain areas, and may optimize throughput in other areas, e.g., taking into account the desired noise levels.

Referring back to FIG. 8, in some demonstrative aspects, the imaging-device cleaner 810 may include a pipe assembly, which may be configured to guide the high-pressure air from an outlet of the blower 861 toward the lens 820 of the camera 801, e.g., as described below.

In some demonstrative aspects, as shown in FIG. 8, the pipe assembly may include a pipe 865, e.g., as described below.

For example, pipe 718 (FIG. 7) may include one or more components and/or elements of pipe 865, and/or pipe 718 (FIG. 7) may be configured to perform one or more functionalities of pipe 865.

In some demonstrative aspects, as shown in FIG. 8, the pipe assembly may include a connector 863, which may be configured to fluidly connect the air outlet of the blower 861 to a first end of the pipe 865, e.g., as described below.

For example, connector 714 (FIG. 7) may include one or more components and/or elements of connector 863, and/or connector 714 (FIG. 7) may be configured to perform one or more functionalities of connector 863.

In some demonstrative aspects, as shown in FIG. 8, the pipe assembly may include an air nozzle 867, which may be connected to a second end of the pipe 865, e.g., as described below.

For example, air nozzle 734 (FIG. 7) may include one or more components and/or elements of air nozzle 867, and/or air nozzle 734 (FIG. 7) may be configured to perform one or more functionalities of air nozzle 867.

In some demonstrative aspects, the imaging-device cleaner 810 may include a blower output adapter 849, which may be configured to adapt an airflow between the air outlet of the blower 861 and one or more elements to be connected to the air outlet of the blower 861, e.g., as described below.

For example, adapter 716 (FIG. 7) may include one or more components and/or elements of blower output adapter 849, and/or adapter 716 (FIG. 7) may be configured to perform one or more functionalities of blower output adapter 849.

In some demonstrative aspects, as shown in FIG. 8, blower output adapter 849 may be configured to adapt the airflow between the air outlet of the blower 861 and the connector 863.

In other aspects, blower output adapter 849 may be configured to adapt the airflow between the air outlet of the blower 861 and any other suitable air-conveyor element to be connected to the air outlet of the blower 861, for example, based on an installation configuration of the imaging-device cleaner 810, e.g., as described below.

In some demonstrative aspects, as shown in FIG. 8, imaging-device cleaner 810 may be installed according to a first installation configuration including the pipe assembly, e.g., including connector 863, pipe 865, and air nozzle 867.

For example, this installation configuration may be implemented to provide a technical solution in cases where the blower mechanism 815 is to be installed at some distance from the camera 801, e.g., when the camera 801 is installed in a side mirror of a vehicle.

In some demonstrative aspects, imaging-device cleaner 810 may be installed according to a second installation configuration, which does not include the pipe 865. For example, the second installation configuration may include the air nozzle 867, which may be connected, e.g., by connector 863, to the blower output adapter 849.

For example, this installation configuration may be implemented to provide a technical solution in cases where the blower mechanism 815 is to be installed relatively close to the camera 801, e.g., when the camera is installed behind the fender of the vehicle.

In some demonstrative aspects, imaging-device cleaner 810 may be installed according to a third installation configuration, which does not include the pipe 865 and the connector 863. For example, the third installation configuration may include the air nozzle 867, which may be connected, e.g., directly, to the blower output adapter 849.

For example, this installation configuration may be implemented to provide a technical solution in cases where the blower mechanism 815 is to be installed in close proximity to the camera 801, e.g., when the camera is installed behind the front fascia of the vehicle.

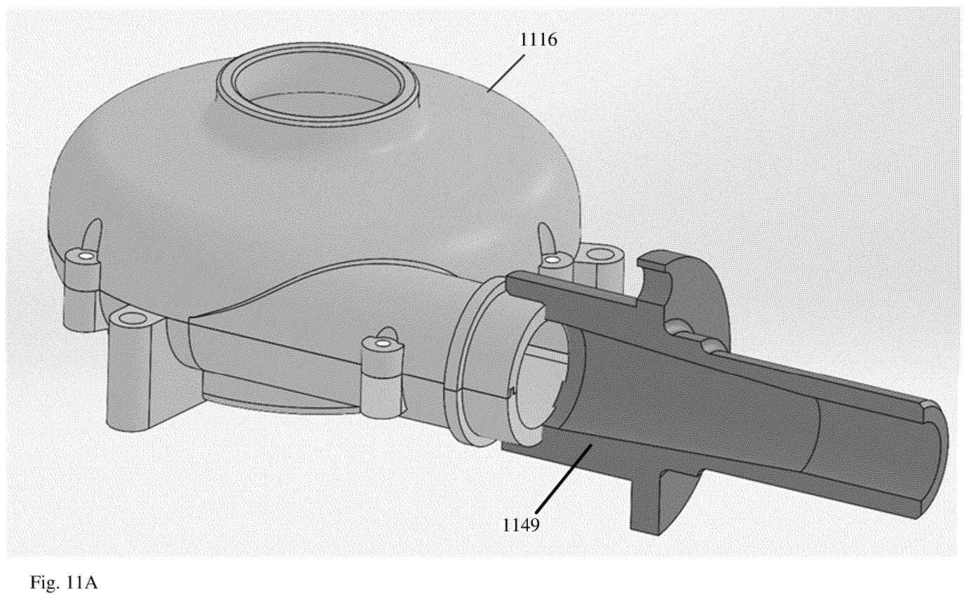

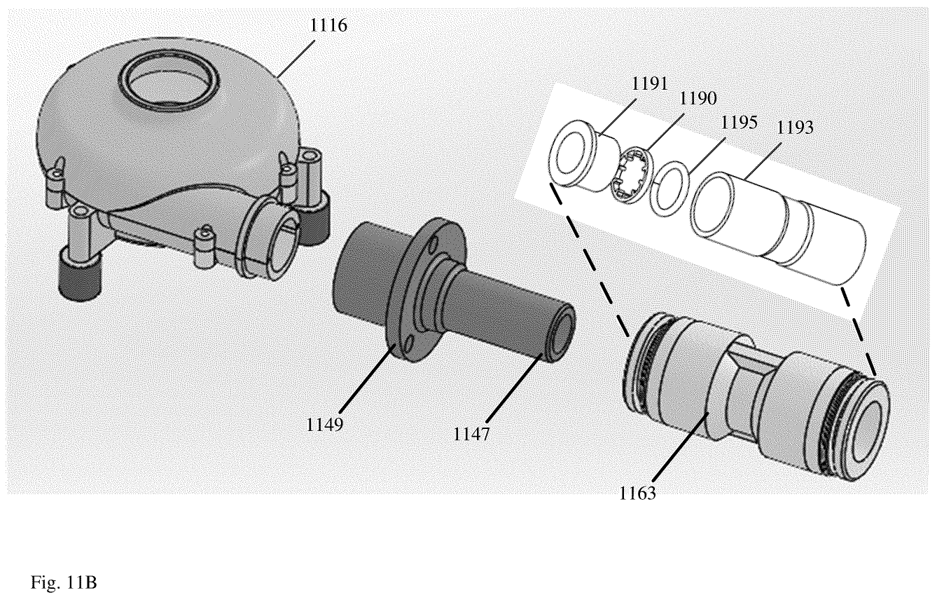

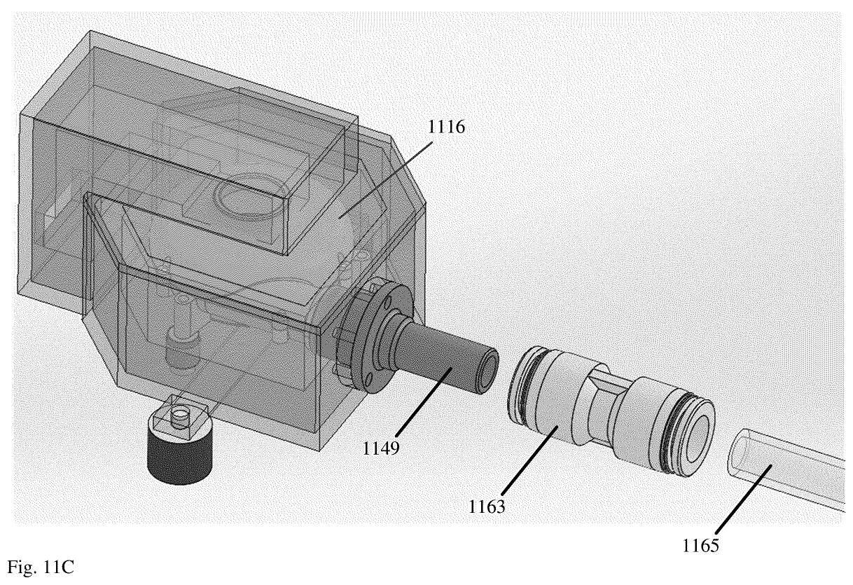

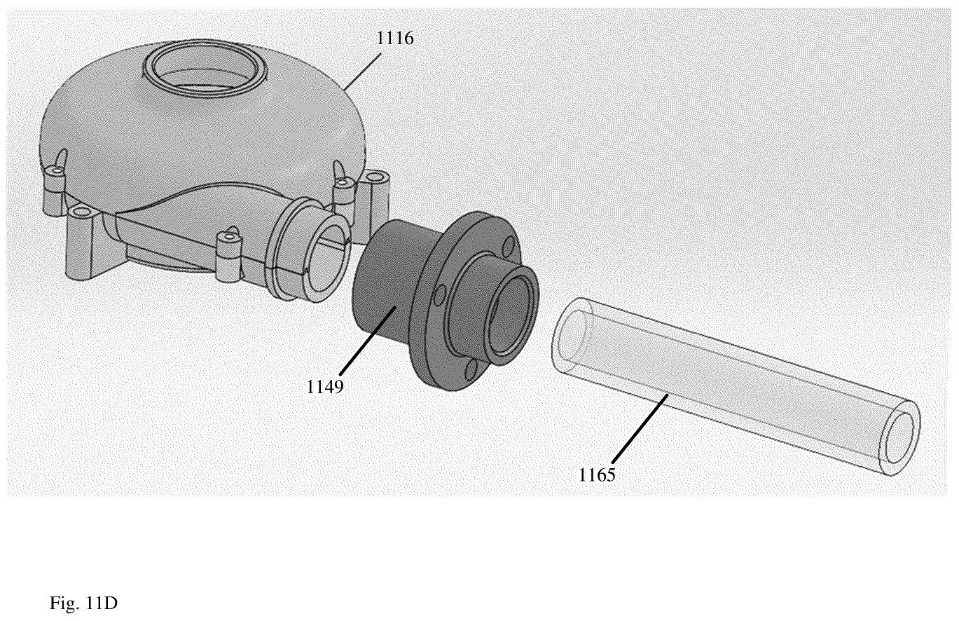

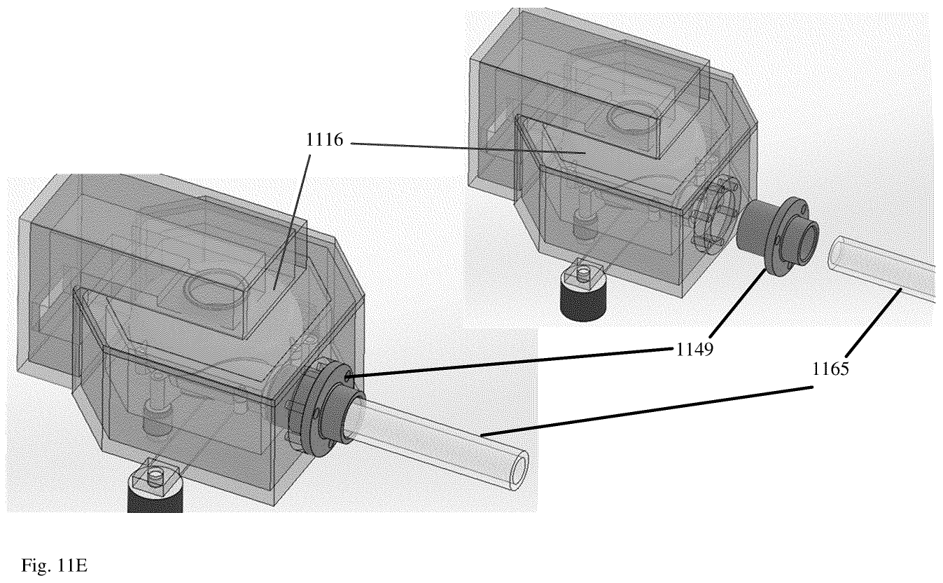

Reference is made to FIGS. 11A, 11B, 11C, 11D, and 11E, which schematically illustrate implementations of a blower output adapter 1149 according to a plurality of different installation configurations, in accordance with some demonstrative aspects.

For example, blower output adapter 849 (FIG. 8) may include blower output adapter 1149.

In some demonstrative aspects, as shown in FIG. 11A, a first end of the blower output adapter 1149 may be configured to be attached, e.g., with force, to the air outlet of a blower 1116, for example, to prevent air leakage.

In some demonstrative aspects, as shown in FIG. 11A, a second end of the blower output adapter 1149 may be configured to be attached to a component to be connected to the air outlet of the blower 1116.

In some demonstrative aspects, as shown in FIG. 11A, blower output adapter 1149 may be configured to provide a technical solution to maintain a relatively smooth, continuous, and/or fluidic transition between the air outlet of the blower 1116 and the component to be connected to the air outlet of the blower.

In some demonstrative aspects, as shown in FIG. 11A, blower output adapter 1149 may be configured to provide a technical solution to maintain a generally gradual, and/or monotonous transition, e.g., a conical-like transition, between a cross section of the air outlet of the blower 1116 and a cross section of the component to be connected to the air outlet of the blower 1116.

In some demonstrative aspects, this configuration of the blower output adapter 1149 may be configured to provide a technical solution to connect the component to the air outlet of the blower 1116, for example, with reduced, e.g., minimal, turbulence of the airflow.

In some demonstrative aspects, this configuration of the blower output adapter 1149 may be configured to provide a technical solution to connect the component to the air outlet of the blower 1116, for example, with reduced, e.g., minimal, losses of the airflow.

In some demonstrative aspects, as shown in FIGS. 11B and 11C, blower output adapter 1149 may be configured to provide a technical solution for transition between the air outlet of the blower 1116 and a connector 1163, e.g., connector 863 (FIG. 8).

For example, as shown in FIG. 11C, the connector 1163 may be utilized to connect a pipe 1165, e.g., pipe 865 (FIG. 8), to the blower 1116.

In some demonstrative aspects, the connector 1163 may include a fast connector (fitting), which may be configured to support a fast and/or secure connection between blower output adapter 1149 and pipe 1165.

In one example, connector 1163 may include a PU12 quick fitting, or any other suitable type of connector or fitting.

In some demonstrative aspects, the connector 1163 may be implemented to provide a technical solution to reduce noise from the output of the blower.

In some demonstrative aspects, the connector 1163 may include a plurality of inner fitting grippers 1190, which may be configured to maintain a tight fit between the connector 1163 and the adapter 1149, e.g., as described below.

For example, as shown in FIG. 11B, connector 1163 may include a push-to-connect fitting, which may be configured to support quick and easy assembly, e.g., without tools.

For example, as shown in FIG. 11B, connector 1163 may include a head portion 1191, e.g., formed of a metal substance, e.g., brass, stainless-steel, a plastic substance, or any other suitable substance. For example, the head portion 1191 may be configured to fit over an end of an engaged element to be connected by the connector 1163, e.g., an end 1147 of the output adapter 1149. For example, connector 1163 may include the grippers 1190, which may be configured to grip the engaged element, e.g., the end 1147 of the output adapter 1149, for example, once the engaged element is inserted into the connector 1163. For example, as shown in FIG. 11B, the grippers 1190 may be implemented in the form of ring of springy teeth, for example, as part of a collet mechanism. For example, the grippers 1190 may be formed of a suitable spring metal, or the like. For example, the grippers 1190 may be configured to hold and lock the engaged element, e.g., the end 1147 of the output adapter 1149, to a barrel 1193 of the connector 1163.

For example, as shown in FIG. 11B, the connector 1163 may include a seal, e.g., an O-ring 1195, to seal a gap between the engaged element, e.g., the end 1147 of the output adapter 1149, and the barrel 1193 of the connector 1163.

In some demonstrative aspects, the inner fitting grippers 1190 may be utilized to mitigate the noise from the air outlet of the blower 1116.

For example, upon research and investigation, the inventors have discovered that the springy structure of the inner fitting grippers 1190 combines flexibility and strength, which may be utilized to provide an innovative technical solution to absorb sound energy and convert it into heat or another form of energy, which may support reduction in noise intensity.

In some demonstrative aspects, as shown in FIGS. 11D and 11E, blower output adapter 1149 may be configured to provide a technical solution for transition between the air outlet of the blower 1116 and a pipe 1165, e.g., pipe 865 (FIG. 8).

For example, the blower output adapter 1149 may be connected directly to the pipe 1165, for example, in installations where there may not be enough space for the connector 1163, e.g., as shown in FIG. 11E.

Referring back to FIG. 8, in some demonstrative aspects, pipe 865 may be configured to have an internal diameter, which may fit a diameter of an output of the blower output adapter 849.

In some demonstrative aspects, pipe 865 may be formed of a material having a relatively low friction coefficient, which may be suitable for conveying the air from the blower 861 with reduced, e.g., minimal, loss.

In some demonstrative aspects, it has been shown by experiment, that the pipe 865 may be implemented with a length of up to about 1.5 meters, or even longer, for example, while maintaining acceptable performance for conveying the airflow from the blower 861 to the nozzle 867.

For example, the pipe 865 may be implemented to provide a technical solution for cases where the blower mechanism 815 is to be located relatively far from the camera 801.

In one example, the pipe 865 may be implemented to provide a technical solution to support an installation configuration where the camera 801 may be located in a side mirror of a vehicle, while the blower mechanism 815 may be located in a door of the vehicle.

In some demonstrative aspects, air nozzle 867 may be configured to direct the high-pressure airflow, e.g., as received via the pipe 865 or directly from the blower output adapter 849, towards the lens 820 of the camera 801, e.g., as described below.

In some demonstrative aspects, air nozzle 867 may be configured to spread the high-pressure airflow onto the lens 820 of the camera 801, for example, at a relatively high pressure and/or velocity, e.g., as described below.

In some demonstrative aspects, air nozzle 867 may be configured to spread the high-pressure airflow onto the lens 820 of the camera 801, for example, according to a relatively uniform distribution profile, e.g., as described below.

In some demonstrative aspects, air nozzle 867 may be configured to be attached, e.g., with force, to the pipe 865, to the connector 863, or to the blower output adapter 849, e.g., according to an installation configuration, for example, to prevent air leakage.

In some demonstrative aspects, air nozzle 867 may be configured to maintain a relatively smooth, continuous, and/or fluidic transition between an inlet of the air nozzle 867, e.g., from the pipe 865, the connector 863, or the blower output adapter 849, to an outlet of the air nozzle 867.

In some demonstrative aspects, air nozzle 867 may be configured to maintain a generally gradual, and/or monotonous transition, e.g., a conical-like transition, between a cross section of the inlet of the air nozzle 867, e.g., from the pipe 865, the connector 863, or the blower output adapter 849, and a cross section of the outlet of the air nozzle 867.

In some demonstrative aspects, this configuration of the air nozzle 867 may be configured to provide a technical solution to direct the airflow onto the lens 820 of the camera 801, for example, with reduced, e.g., minimal, turbulence of the airflow.

In some demonstrative aspects, this configuration of the air nozzle 867 may be configured to provide a technical solution to direct the airflow onto the lens 820 of the camera 801, for example, with reduced, e.g., minimal, losses of the airflow.

In some demonstrative aspects, an outlet of air nozzle 867 may be designed according to physical principals, for example, to provide a technical solution to support efficient spreading of the airflow on the lens 820 of the camera 801, for example, with sufficient pressure and speed to support proper cleaning of the lens 820, e.g., as described below.

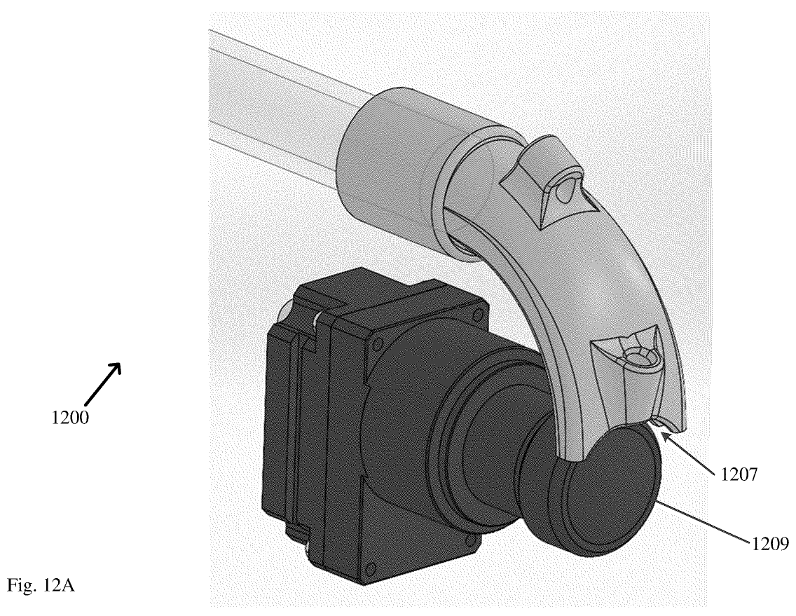

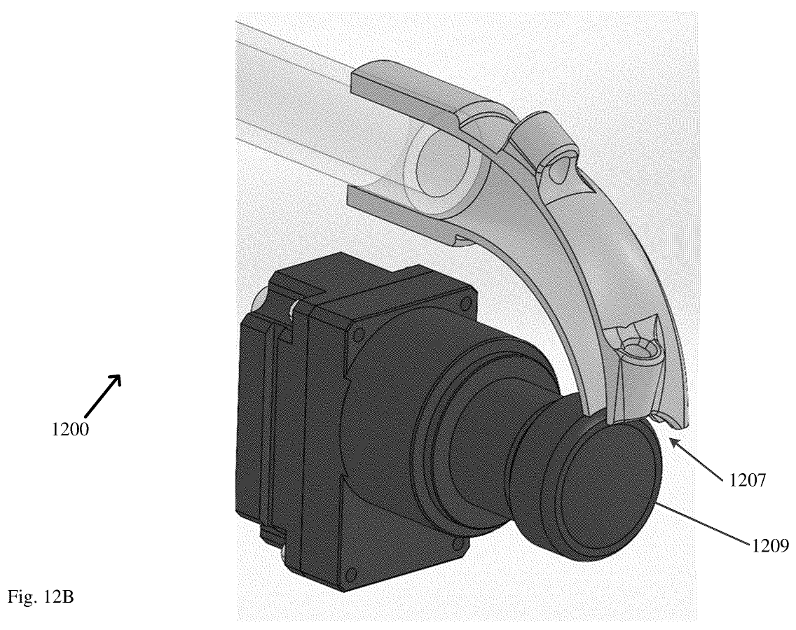

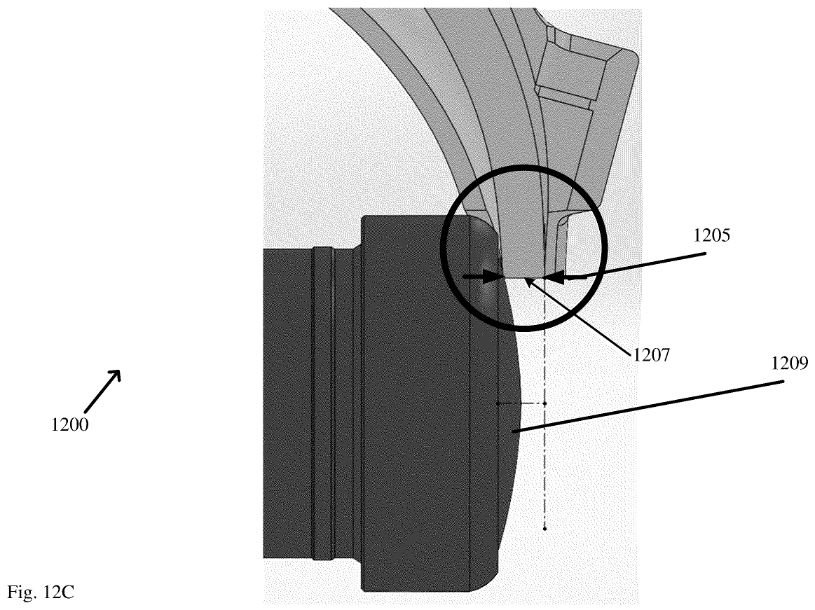

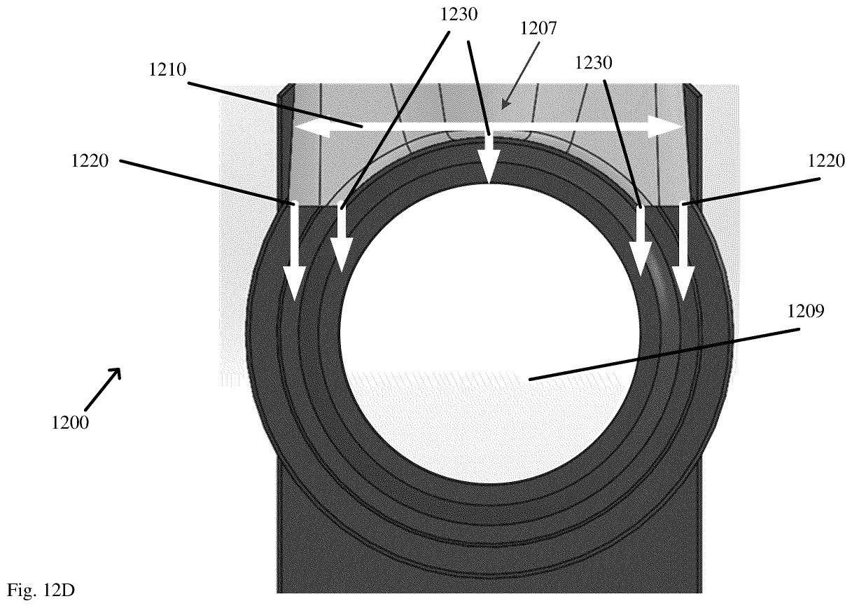

Reference is made to FIGS. 12A-12D, which schematically illustrate an air nozzle 1200, in accordance with some demonstrative aspects.

For example, air nozzle 867 (FIG. 8) may include one or more components and/or elements of air nozzle 1200, and/or air nozzle 867 (FIG. 8) may be configured to perform one or more functionalities of air nozzle 1200.

In some demonstrative aspects, as shown in FIGS. 12A-12D, an outlet 1207 of air nozzle 1200 may be configured to be placed in close proximity to a lens 1209 of a camera, for example, while not substantially obstructing a field of view of the camera, or obstructing no more than a predefined portion of the field of view of the camera.

In some demonstrative aspects, as shown in FIG. 12C, a height 1205 of the outlet 1207 of air nozzle 1200 may be configured to extend above a height of the lens 1209 of the camera.

In some demonstrative aspects, as shown in FIG. 12C, a height 1205 of the outlet of air nozzle 1200 may be configured to be placed in close proximity to a perimeter of the lens 1209, for example, such that the outlet 1207 of air nozzle 1200 may provide the airflow in an area substantially covering the lens 1209.

In some demonstrative aspects, as shown in FIG. 12D, a width 1210 of the outlet of air nozzle 1200 may be configured to be a wider, e.g., about 0.5 mm wider, than the lens 1209.

For example, the airflow at areas 1220 close to the inner surface of the outlet 1207 of air nozzle 1200 may have a velocity close to zero. Accordingly, configuring the width 1210 of the outlet 1207 of air nozzle 1200 may be configured to be wider than the width of the lens 1209 may provide a technical solution to support distribution of the airflow 1230 across substantially an entire surface of the lens 1209.

In some demonstrative aspects, as shown in FIG. 12D, a shape of the outlet 1207 of air nozzle 1200 may be configured, for example, based on a shape of the lens 1209.

For example, as shown in FIG. 12D, the outlet 1207 of air nozzle 1200 may be configured to have substantially circular arc shape, which may conform to the shape of the lens 1209.

For example, configuring the shape of the outlet 1207 of air nozzle 1200 to conform to the shape of the lens 1209 may provide a technical solution to support a substantially uniform distribution, e.g., in terms of velocity and/or pressure, of the airflow 1230 on the surface of the lens 1209.

For example, configuring the shape of the outlet 1207 of air nozzle 1200 to conform to the shape of the lens 1209 may provide a technical solution to maintain a substantially uniform distance from the outlet of air nozzle 1200 to the surface of the lens 1209, which may result in the substantially uniformly distributed airflow 1230, e.g., at substantially the same maximal airflow speed.

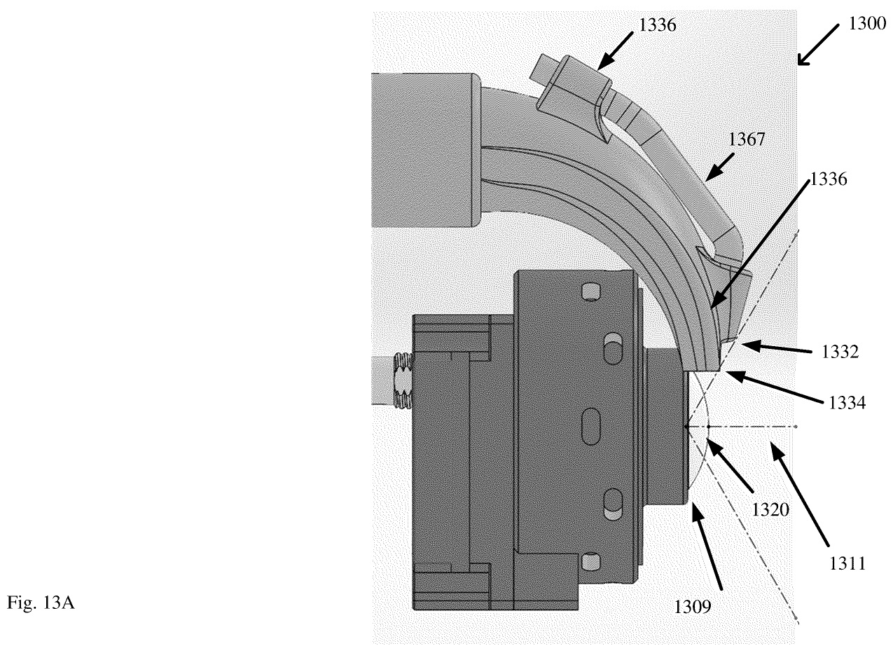

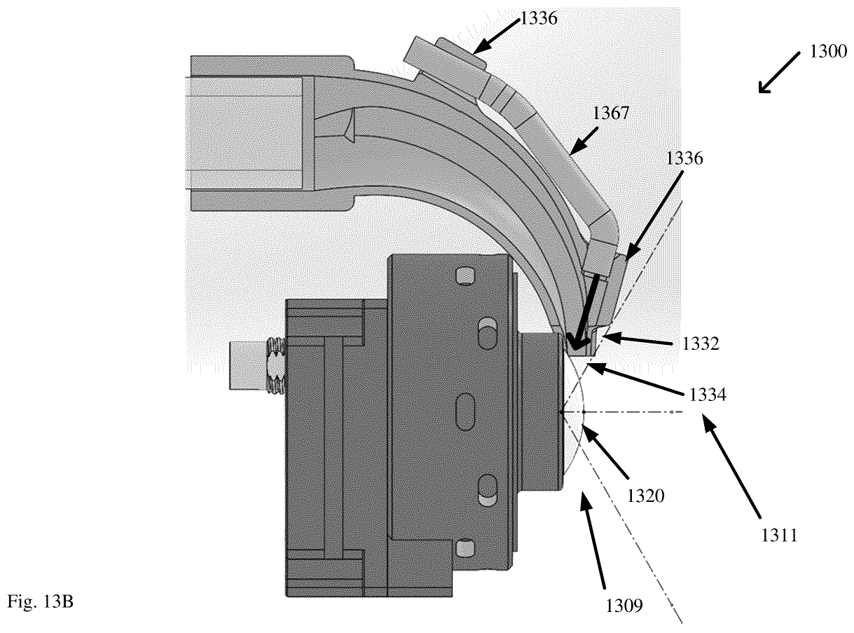

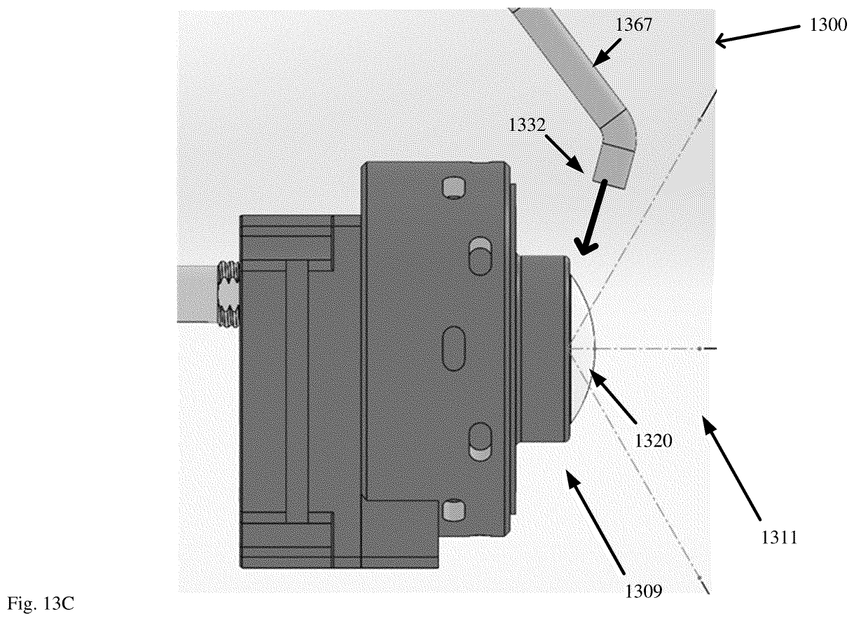

Reference is made to FIGS. 13A, 13B, and 13C, which schematically illustrate a configuration of a nozzle assembly 1300 including an air nozzle 1334 and a sprinkler nozzle 1332, in accordance with some demonstrative aspects.

For example, nozzle assembly 730 (FIG. 7) may include one or more components and/or elements of water nozzle assembly 1300, and/or water nozzle assembly 730 (FIG. 7) may be configured to perform one or more functionalities of nozzle assembly 1300.

In some demonstrative aspects, sprinkler nozzle 1332 may be configured to spread water, e.g., supplied from a water sprinkler tube 1367 onto a lens 1320 of a camera 1309, e.g., as described above.

In some demonstrative aspects, air nozzle 1334 may be configured to spread an airflow onto the lens 1320 of the camera 1309, e.g., as described above.

In some demonstrative aspects, nozzle assembly 1300 may include a nozzle holder 1336 to hold the sprinkler nozzle 1332 and the air nozzle 1334.

In some demonstrative aspects, the nozzle holder 1336 may be configured to maintain a predefined relative positioning between the air nozzle 1334 and the sprinkler nozzle 1332.

In some demonstrative aspects, as shown in FIGS. 13A-13C, the nozzle holder 1336 may be configured to maintain the sprinkler nozzle 1332, for example, such that the sprinkler nozzle 1332 may sprinkle water onto the lens 1320 of the camera 1309.

In one example, the water sprinkler tube 1367 may include a Ø3×Ø2 mm tube. In other aspects, any other tube may be implemented.

In some demonstrative aspects, a second end of the tube 1367 may be connected, e.g., via a valve (not shown), to a water pump (not shown), which may provide a pressurized water flow from a water reservoir (not shown).

In some demonstrative aspects, as shown in FIGS. 13A-13C, the nozzle holder 1336 may be configured to maintain the sprinkler nozzle 1332, for example, such that the sprinkler nozzle 1332 is to sprinkle water at close proximity to an outlet of the air nozzle 1334, e.g., the outlet of air nozzle 1200 (FIG. 12). For example, this configuration may provide a technical solution to support combined operation of the water sprinkler 813 (FIG. 8) and the blower 861 (FIG. 8), e.g., substantially simultaneously, for example, to increase the velocity of the waterflow onto the lens 1320 of the camera 1309.

In some demonstrative aspects, as shown in FIGS. 13A-13C, the nozzle holder 1336 may be configured to maintain the sprinkler nozzle 1332, for example, such that the sprinkler nozzle 1332 is to be positioned at a location and/or orientation, which may not substantially obstruct a field of view 1311 of the camera 1309.

In some demonstrative aspects, as shown in FIGS. 13A-13C, the nozzle holder 1336 may be configured to maintain the sprinkler nozzle 1332, for example, such that the sprinkler nozzle 1332 is to be positioned at a location and/or orientation, which may support a technical solution to sprinkle water covering substantially an entire area of the lens 1320 of the camera 1309, e.g., with a single sprinkle.

In other aspects, the water sprinkler tube 1300 may be positioned at a location and/or orientation, which may be different from the position shown in FIGS. 13A-13C.

Referring back to FIG. 8, in some demonstrative aspects, the ultrasonic vibration generator 826 may be integrated as part of the lens 820.

For example, the ultrasonic vibration generator 826 may be implemented to vibrate a most outer element or layer of the lens 820, which may be exposed to the environment.

In some demonstrative aspects, the ultrasonic vibration generator 826 may be implemented as part of an ultrasonic vibration assembly, which may include a window, which may be placed over the lens 820. For example, the ultrasonic vibration generator 826 may be operated to vibrate the window, for example, to remove foreign matter from an outer surface of the window, e.g., as described below.

In some demonstrative aspects, the ultrasonic vibration assembly may be implemented to provide a technical solution to utilize an ultrasonic vibration mechanism, for example, while avoiding vibrations to the lens 820, which may result in a degraded focus of the lens 820.

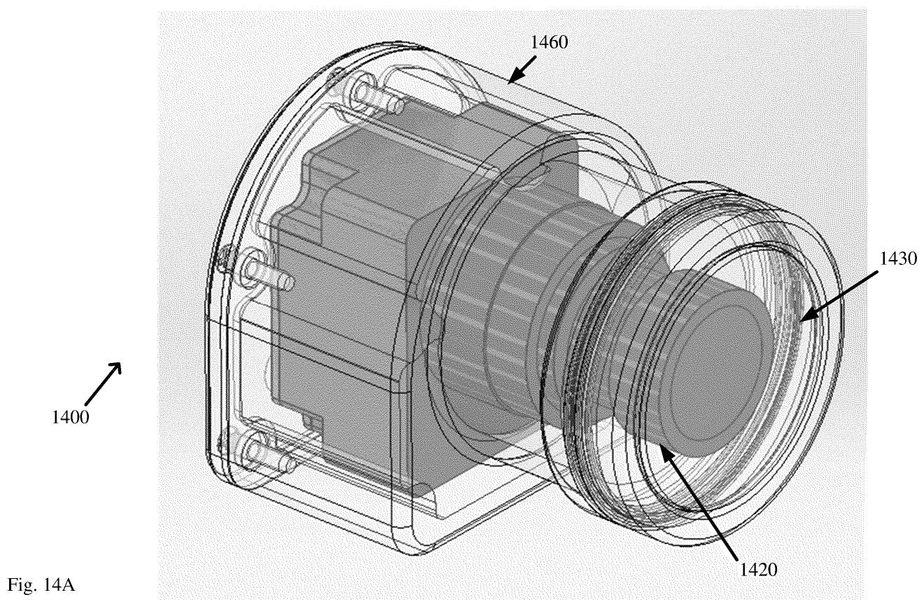

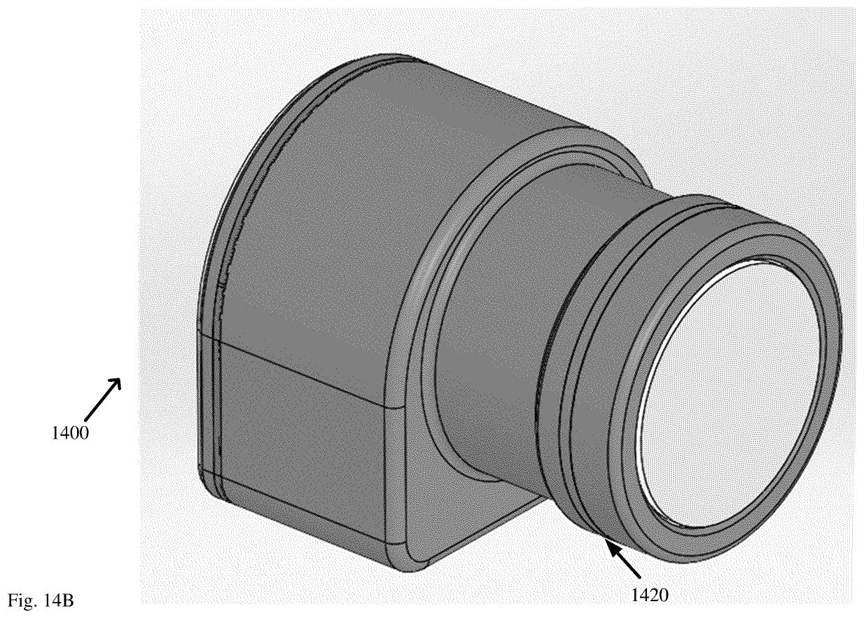

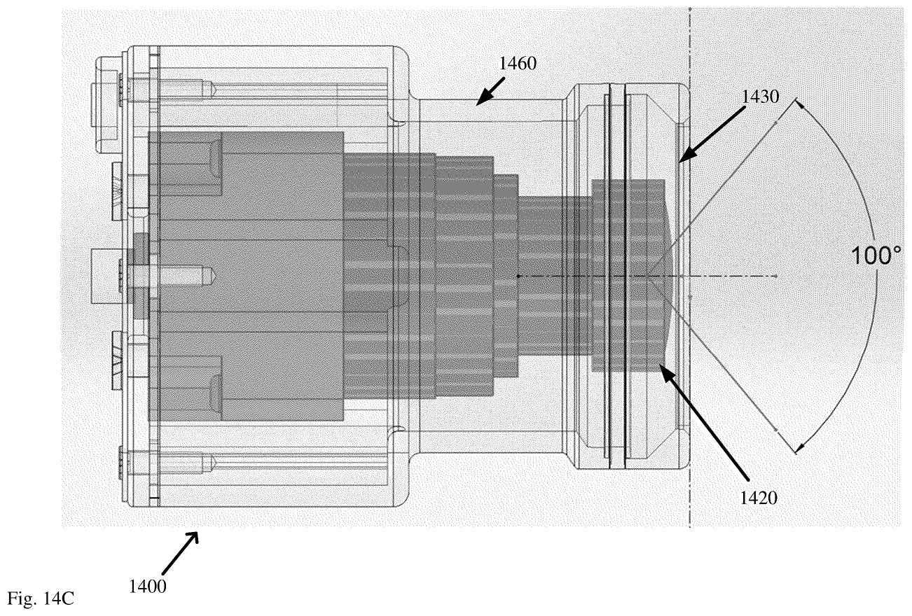

Reference is made to FIGS. 14A, 14B, and 14C, which schematically illustrate an ultrasonic vibration assembly 1400, in accordance with some demonstrative aspects.

For example, ultrasonic vibration generator 626 (FIG. 6) may be implemented as part of, or may include one or more components and/or elements of ultrasonic vibration assembly 1400, and/or ultrasonic vibration generator 626 (FIG. 6) may be configured to perform one or more operations and/or functionalities of ultrasonic vibration assembly 1400.

In some demonstrative aspects, as shown in FIGS. 14A-14C, ultrasonic vibration assembly 1400 may include a housing 1460, which may be configured to enclose a camera 1420.

In some demonstrative aspects, as shown in FIGS. 14A-14C, the housing 1460 of the ultrasonic vibration assembly 1400 may include a window 1430. For example, the housing 1460 may be configured to maintain the camera 1420, for example, such that the window 1430 may be positioned substantially in front of the lens of the camera 1420.

In some demonstrative aspects, the window 1430 may be configured to provide a field of view, which may not obstruct and/or distort a field view of the lens of the camera 1420.

In some demonstrative aspects, the housing 1460 of the ultrasonic vibration assembly 1400 may be implemented to provide a technical solution, which may be relatively easy to install and/or maintain.

In some demonstrative aspects, the housing 1460 of the ultrasonic vibration assembly 1400 may be implemented to provide a technical solution to support good cleaning capabilities.

In some demonstrative aspects, a design of an ultrasonic vibration mechanism, e.g., for implementing ultrasonic vibration generator 826 (FIG. 8) may take into consideration one or more technical aspects of the lens to be protected, e.g., lens 820 (FIG. 8).

In one example, in some use cases a camera, e.g., camera 801 (FIG. 8) may require a relatively wide field of view, e.g., of 100 degrees or wider, which may not be supported by the window of the ultrasonic vibration assembly 1400. According to this example, the ultrasonic vibration mechanism may be implemented in the form of the integrated ultrasonic vibration generator, which may be integrated as part of the lens, e.g., as described above.

In another example, in some use cases a camera, e.g., camera 801 (FIG. 8) may have a relatively high resolution, which may not be supported by the integrated ultrasonic vibration generator. According this example, the ultrasonic vibration mechanism may be implemented in the form of the ultrasonic vibration assembly 1400.

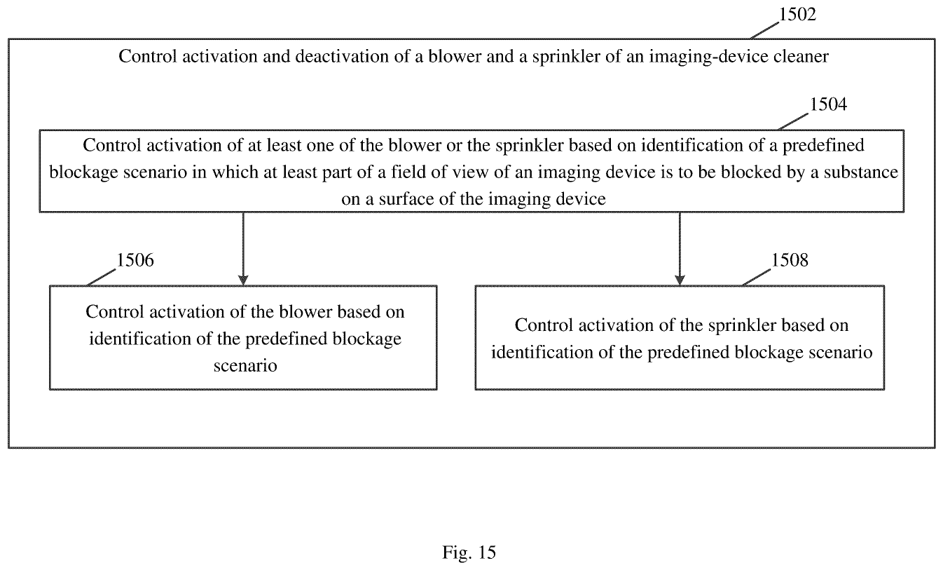

Reference is made to FIG. 15, which schematically illustrates method of vehicular imaging-device cleaning, in accordance with some demonstrative aspects. For example, controller 202 (FIG. 2), and/or controller 602 (FIG. 2) may be configured to implement one or more operations and/or functionalities according to the method of FIG. 15.

In some demonstrative aspects, as indicated at block 1502, the method may include controlling activation and deactivation of a blower and a sprinkler of an imaging-device cleaner. For example, controller 602 (FIG. 6) may be configured to control activation and deactivation of a blower 615 (FIG. 6) and a sprinkler 613 (FIG. 6) of an imaging-device cleaner 610 (FIG. 1), e.g., as described above.

In some demonstrative aspects, as indicated at block 1504, controlling activation and deactivation of the blower and the sprinkler may include identifying a predefined blockage scenario in which at least part of a field of view of an imaging device is to be blocked by a substance on a surface of the imaging device. For example, controller 602 (FIG. 6) may be configured to identify the predefined blockage scenario, e.g., as described above.

In some demonstrative aspects, as indicated at block 1506, controlling activation and deactivation of the blower and the sprinkler may include controlling activation of the blower based on identification of the predefined blockage scenario. For example, controller 602 (FIG. 6) may be configured to control activation of the blower 615 (FIG. 6) based on identification of the predefined blockage scenario, e.g., as described above.

In some demonstrative aspects, as indicated at block 1508, controlling activation and deactivation of the blower and the sprinkler may include controlling activation of the sprinkler based on identification of the predefined blockage scenario. For example, controller 602 (FIG. 6) may be configured to control activation of the sprinkler 613 (FIG. 6) based on identification of the predefined blockage scenario, e.g., as described above.

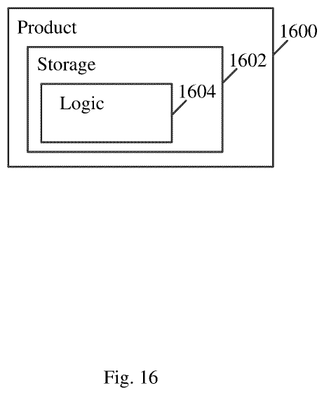

Reference is made to FIG. 16, which schematically illustrates a product of manufacture 1600, in accordance with some demonstrative aspects. Product 1600 may include one or more tangible computer-readable (“machine-readable”) non-transitory storage media 1602, which may include computer-executable instructions, e.g., implemented by logic 1604, operable to, when executed by at least one computer processor, enable the at least one computer processor to perform, trigger and/or implement one or more operations and/or functionalities described with reference to the FIGS. 1-15, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1600 and/or machine readable storage media 1602 may include one or more types of computer-readable storage media capable of storing data, including volatile memory, non-volatile memory, removable or non-removable memory, erasable or non-erasable memory, writeable or re-writeable memory, and the like. For example, machine readable storage media 1602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an imaging-device cleaning system comprising a blower configured to provide an airflow to be applied onto a surface of an imaging device; a sprinkler configured to sprinkle a liquid onto the surface of the imaging device; and a controller configured to control activation and deactivation of the blower and the sprinkler, the controller configured to control activation of at least one of the blower or the sprinkler based on identification of a predefined blockage scenario in which at least part of a field of view of the imaging device is to be blocked by a substance on the surface.

Example 2 includes the subject matter of Example 1, and optionally, wherein the blower comprises an air blower having a blower input and a blower output; and a housing configured to enclose the air blower, the housing comprising an air inlet; an air outlet; an inlet path to provide air from the air inlet to the blower input; and an outlet path to provide the airflow from the blower output to the air outlet.

Example 3 includes the subject matter of Example 2, and optionally, wherein at least part of the inlet path comprises a noise-absorbing path configured to absorb noise generated by the air blower.

Example 4 includes the subject matter of Example 3, and optionally, wherein the noise-absorbing path comprises a labyrinth-like path comprising one or more turns.

Example 5 includes the subject matter of Example 3 or 4, and optionally, wherein the noise-absorbing path is at least partially covered by a noise absorbing material.

Example 6 includes the subject matter of Example 5, and optionally, wherein the noise absorbing material comprises Polyurethane.

Example 7 includes the subject matter of any one of Examples 2-6, and optionally, wherein the housing comprises a noise absorbing material.

Example 8 includes the subject matter of any one of Examples 2-7, and optionally, wherein the blower comprises one or more blower dampers connected between the air blower and the housing, the one or more blower dampers configured to dampen vibrations from the air blower; and one or more housing dampers to connect the housing to a housing support, the one or more housing dampers configured to dampen vibrations from the housing.

Example 9 includes the subject matter of any one of Examples 2-8, and optionally, comprising a connector configured to fluidly connect between the air outlet and a pipe to guide the airflow, wherein the connector is configured to mitigate noise from the air outlet.

Example 10 includes the subject matter of Example 9, and optionally, wherein the connector comprises a plurality of inner fitting grippers configured to maintain a tight fit between the connector and the air outlet, the inner fitting grippers to mitigate the noise from the air outlet.

Example 11 includes the subject matter of any one of Examples 2-10, and optionally, comprising an adapter to fluidically connect the air outlet to an air-conveyor, which is to convey the airflow towards the surface of the imaging device, wherein the adapter is configured to convey the airflow via a generally monotonous transition between the air outlet and the air-conveyor.

Example 12 includes the subject matter of any one of Examples 1-11, and optionally, comprising a nozzle assembly comprising a sprinkler nozzle configured to spread the liquid onto the surface of the imaging device; an air nozzle configured to spread the airflow onto the surface of the imaging device; and a nozzle holder to hold the sprinkler nozzle and the air nozzle, the nozzle holder configured to maintain a predefined relative positioning between the air nozzle and the sprinkler nozzle.

Example 13 includes the subject matter of Example 12, and optionally, wherein the nozzle holder is configured to maintain the air nozzle above the surface of the imaging device, and the sprinkler nozzle above the air nozzle.

Example 14 includes the subject matter of Example 12 or 13, and optionally, wherein the nozzle holder is configured to maintain the air nozzle and the sprinkler nozzle outside at least 90 percent of the field of view of the imaging device.

Example 15 includes the subject matter of any one of Examples 12-14, and optionally, wherein the predefined relative positioning between the air nozzle and the sprinkler nozzle is configured such that, when the blower is activated simultaneously with the sprinkler, the airflow is to increase a velocity of the liquid towards the surface.

Example 16 includes the subject matter of any one of Examples 1-15, and optionally, comprising a sprinkler nozzle to spread the liquid at a predefined sprinkling direction onto the surface of the imaging device; and an air nozzle to spread the airflow at a predefined airflow direction onto the surface of the imaging device, wherein the predefined airflow direction is identical to the predefined sprinkling direction or within a range of no more than 10 degrees of the predefined sprinkling direction.

Example 17 includes the subject matter of any one of Examples 1-16, and optionally, comprising an air nozzle configured to spread the airflow onto the surface of the imaging device.

Example 18 includes the subject matter of Example 17, and optionally, comprising a holder to position a nozzle output of the air nozzle in proximity to a perimeter of the surface of the imaging device and above the surface of the imaging device, such that the nozzle output is to spread the airflow onto substantially an entirety of the surface of the imaging device.

Example 19 includes the subject matter of Example 17 or 18, and optionally, wherein a nozzle output of the air nozzle is configured to substantially uniformly distribute the airflow on substantially the entirety of the surface of the imaging device.

Example 20 includes the subject matter of any one of Examples 17-19, and optionally, wherein a width of a nozzle output of the air nozzle is wider than a width of the surface of the imaging device.

Example 21 includes the subject matter of Example 20, and optionally, wherein a difference between the width of the nozzle output of the air nozzle and the width of the surface of the imaging device is in a range between 0.5 millimeter (mm) and 1 mm.

Example 22 includes the subject matter of any one of Examples 17-21, and optionally, wherein a shape of a nozzle output of the air nozzle is configured to conform to a shape of a perimeter of the surface of the imaging device.

Example 23 includes the subject matter of any one of Examples 17-22, and optionally, wherein the air nozzle comprises an air path configured to gradually and monotonously transition between a cross section of a nozzle input of the air nozzle and a cross section of a nozzle output of the air nozzle.

Example 24 includes the subject matter of any one of Examples 17-23, and optionally, comprising a pipe to guide the airflow from the blower to the air nozzle.

Example 25 includes the subject matter of Example 24, and optionally, wherein an inner surface of the pipe has a friction coefficient of less than 0.6.

Example 26 includes the subject matter of Example 25, and optionally, wherein the inner surface of the pipe has a friction coefficient in a range of 0.2-0.5.

Example 27 includes the subject matter of any one of Examples 1-26, and optionally, wherein the blower is controllably operative at a plurality of blower operation modes having a plurality of associated blower noise levels, wherein the controller is configured to control activation of the blower at a selected blower operation mode based on a predefined activation criterion, the predefined activation criterion based on a blower noise level associated with the selected blower operation mode.

Example 28 includes the subject matter of Example 27, and optionally, wherein the predefined activation criterion is based on one or more blockage attributes of the predefined blockage scenario.

Example 29 includes the subject matter of any one of Examples 1-28, and optionally, wherein the controller is configured to determine an activation setting based on the predefined blockage scenario, and to control activation of at least one of the blower or the sprinkler according to the activation setting.

Example 30 includes the subject matter of Example 29, and optionally, wherein the activation setting is to define a cleaning procedure to remove the substance from the surface of the imaging device.

Example 31 includes the subject matter of Example 29 or 30, and optionally, wherein the activation setting is to define whether or not the blower is to be activated, and whether or not the sprinkler is to be activated.

Example 32 includes the subject matter of any one of Examples 29-31, and optionally, wherein the activation setting is to define an operation mode at which at least one of the blower or the sprinkler is to be activated.

Example 33 includes the subject matter of any one of Examples 29-32, and optionally, wherein the activation setting is to define an activation time duration at which at least one of the blower or the sprinkler is to be active.

Example 34 includes the subject matter of any one of Examples 29-33, and optionally, wherein the activation setting is based on at least one of a type of the substance, an amount of the substance, a location of the substance on the surface of the imaging device, or a percentage of the field of view blocked by the substance.

Example 35 includes the subject matter of any one of Examples 29-34, and optionally, wherein the activation setting is based on a real-time driving scenario of a vehicle comprising the imaging device.

Example 36 includes the subject matter of any one of Examples 29-35, and optionally, wherein the activation setting is to define an activation cycle comprising activation of the sprinkler followed by activation of the blower.

Example 37 includes the subject matter of Example 36, and optionally, wherein the controller is configured to repeat activation of the sprinkler and the blower for a plurality of activation cycles until identification that a cleaning criterion is met.

Example 38 includes the subject matter of any one of Examples 29-37, and optionally, wherein the controller is configured to determine the activation setting to activate only the blower based on a determination that the predefined blockage scenario comprises a water-spot scenario in which the substance comprises spots of water.

Example 39 includes the subject matter of any one of Examples 29-38, and optionally, wherein the controller is configured to determine the activation setting to activate the sprinkler for a first time period and to activate the blower for a second time period after an end of the first time period, based on a determination that the predefined blockage scenario comprises a solid-substance scenario in which the substance comprises a solid substance.

Example 40 includes the subject matter of any one of Examples 29-39, and optionally, wherein the controller is configured to determine the activation setting to activate the sprinkler and the blower simultaneously, based on a determination that the predefined blockage scenario comprises a mixed-substance scenario in which the substance comprises a mixture of water and a solid substance.

Example 41 includes the subject matter of any one of Examples 1-40, and optionally, wherein the controller is configured to activate the blower to provide the airflow at a sufficient velocity such that the airflow is to be provided onto the surface of the imaging device with a velocity of at least 30 meters per second (m/s).

Example 42 includes the subject matter of any one of Examples 1-41, and optionally, wherein the controller is configured to activate the blower at a blower power level, which is based on the predefined blockage scenario.

Example 43 includes the subject matter of any one of Examples 1-42, and optionally, wherein the controller is configured to activate the blower at a first blower power level based on identification of a first predefined blockage scenario, and to activate the blower at a second blower power level, different from the first power level, based on identification of a second predefined blockage scenario different from the first predefined blockage scenario.

Example 44 includes the subject matter of any one of Examples 1-43, and optionally, wherein the surface of the imaging device comprises a hydrophobic coating to repel liquid matter.

Example 45 includes the subject matter of any one of Examples 1-44, and optionally, wherein the controller is configured to activate an ultrasonic vibration generator to generate vibrations to at least partially remove at least one of the substance or drops of the liquid from the surface of the imaging device.

Example 46 includes the subject matter of Example 45, and optionally, wherein the controller is configured to set the ultrasonic vibration generator to generate the vibrations at a vibration frequency, which is based on the predefined blockage scenario.

Example 47 includes the subject matter of any one of Examples 1-46, and optionally, wherein the controller is configured to control activation of a plurality of imaging-device cleaners to clean a respective plurality of imaging-device surfaces, wherein an imaging-device cleaner of the plurality of imaging-device cleaners comprises the blower and the sprinkler.

Example 48 includes the subject matter of any one of Examples 1-47, and optionally, wherein a maximal blower noise level of the blower is no more than 50 decibel (dB).

Example 49 includes the subject matter of any one of Examples 1-48, and optionally, wherein a maximal blower noise level of the blower is no more than 45 decibel (dB).

Example 50 includes the subject matter of any one of Examples 1-49, and optionally, wherein the liquid is water or an aqueous solution.

Example 51 includes the subject matter of any one of Examples 1-50, and optionally, wherein the surface of the imaging device comprises a lens surface of a lens of the imaging device.

Example 52 includes the subject matter of any one of Examples 1-51, and optionally, wherein the surface of the imaging device comprises a protective surface to protect a lens of the imaging device.

Example 53 includes a vehicle comprising one or more imaging devices; the imaging-device cleaning system of any one of Examples 1-52 configured to clean a surface of at least one imaging device of the one or more imaging devices; at least one processor to generate sensor information based on one or more images sensed by the one or more imaging devices; and a vehicle system controller to control one or more vehicular systems of the vehicle based on the sensor information.

Example 54 includes the subject matter of Example 53, and optionally, comprising a plurality of imaging-device cleaners to clean a respective plurality of imaging-device surfaces of a plurality of imaging devices at a plurality of locations in the vehicle, wherein an imaging-device cleaner of the plurality of imaging-device cleaners comprises the blower and the sprinkler.

Example 55 includes a controller of an imaging-device cleaning system configured to perform any of the described operations of any of Examples 1-52.

Example 56 includes a vehicle comprising the subject matter of any of Examples 1-52.

Example 57 includes an apparatus comprising means for performing any of the described operations of any of Examples 1-52.

Example 58 includes a system comprising means for performing any of the described operations of any of Examples 1-52.

Example 59 includes a machine-readable medium that stores instructions for execution by a processor to perform any of the described operations of any of Examples 1-52.

Example 60 comprises a product comprising one or more tangible computer-readable non-transitory storage media comprising instructions operable to, when executed by at least one processor, enable the at least one processor to cause a device and/or system to perform any of the described operations of any of Examples 1-52.

Example 61 includes an apparatus comprising a memory; and processing circuitry configured to perform any of the described operations of any of Examples 1-52.

Example 62 includes a method including any of the described operations of any of Examples 1-52.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An imaging-device cleaning system comprising:
a blower configured to provide an airflow to be applied onto a surface of an imaging device;
a sprinkler configured to sprinkle a liquid onto the surface of the imaging device; and
a controller configured to control activation and deactivation of the blower and the sprinkler, the controller configured to control activation of at least one of the blower or the sprinkler based on identification of a predefined blockage scenario in which at least part of a field of view of the imaging device is to be blocked by a substance on the surface.

2. The imaging-device cleaning system of claim 1, wherein the blower comprises:
an air blower having a blower input and a blower output; and
a housing configured to enclose the air blower, the housing comprising:
an air inlet;
an air outlet;
an inlet path to provide air from the air inlet to the blower input; and
an outlet path to provide the airflow from the blower output to the air outlet.

3. The imaging-device cleaning system of claim 2, wherein at least part of the inlet path comprises a noise-absorbing path configured to absorb noise generated by the air blower.

4. The imaging-device cleaning system of claim 3, wherein the noise-absorbing path comprises a labyrinth-like path comprising one or more turns.

5. The imaging-device cleaning system of claim 2, wherein the blower comprises:
one or more blower dampers connected between the air blower and the housing, the one or more blower dampers configured to dampen vibrations from the air blower; and
one or more housing dampers to connect the housing to a housing support, the one or more housing dampers configured to dampen vibrations from the housing.

6. The imaging-device cleaning system of claim 2 comprising a connector configured to fluidly connect between the air outlet and a pipe to guide the airflow, wherein the connector is configured to mitigate noise from the air outlet.

7. The imaging-device cleaning system of claim 6, wherein the connector comprises a plurality of inner fitting grippers configured to maintain a tight fit between the connector and the air outlet, the inner fitting grippers to mitigate the noise from the air outlet.

8. The imaging-device cleaning system of claim 1 comprising a nozzle assembly comprising:
a sprinkler nozzle configured to spread the liquid onto the surface of the imaging device;
an air nozzle configured to spread the airflow onto the surface of the imaging device; and
a nozzle holder to hold the sprinkler nozzle and the air nozzle, the nozzle holder configured to maintain a predefined relative positioning between the air nozzle and the sprinkler nozzle.

9. The imaging-device cleaning system of claim 8, wherein the nozzle holder is configured to maintain the air nozzle above the surface of the imaging device, and the sprinkler nozzle above the air nozzle.

10. The imaging-device cleaning system of claim 8, wherein the predefined relative positioning between the air nozzle and the sprinkler nozzle is configured such that, when the blower is activated simultaneously with the sprinkler, the airflow is to increase a velocity of the liquid towards the surface.

11. The imaging-device cleaning system of claim 1 comprising:
a sprinkler nozzle to spread the liquid at a predefined sprinkling direction onto the surface of the imaging device; and
an air nozzle to spread the airflow at a predefined airflow direction onto the surface of the imaging device, wherein the predefined airflow direction is identical to the predefined sprinkling direction or within a range of no more than 10 degrees of the predefined sprinkling direction.

12. The imaging-device cleaning system of claim 1 comprising an air nozzle configured to spread the airflow onto the surface of the imaging device.

13. The imaging-device cleaning system of claim 12 comprising a holder to position a nozzle output of the air nozzle in proximity to a perimeter of the surface of the imaging device and above the surface of the imaging device, such that the nozzle output is to spread the airflow onto substantially an entirety of the surface of the imaging device.

14. The imaging-device cleaning system of claim 12, wherein the air nozzle comprises an air path configured to gradually and monotonously transition between a cross section of a nozzle input of the air nozzle and a cross section of a nozzle output of the air nozzle.

15. The imaging-device cleaning system of claim 1, wherein the blower is controllably operative at a plurality of blower operation modes having a plurality of associated blower noise levels, wherein the controller is configured to control activation of the blower at a selected blower operation mode based on a predefined activation criterion, the predefined activation criterion based on a blower noise level associated with the selected blower operation mode.

16. The imaging-device cleaning system of claim 1, wherein the controller is configured to determine an activation setting based on the predefined blockage scenario, and to control activation of at least one of the blower or the sprinkler according to the activation setting.

17. The imaging-device cleaning system of claim 16, wherein the activation setting is based on at least one of a type of the substance, an amount of the substance, a location of the substance on the surface of the imaging device, a percentage of the field of view blocked by the substance, and/or a real-time driving scenario of a vehicle comprising the imaging device.

18. The imaging-device cleaning system of claim 16, wherein the activation setting is to define an activation cycle comprising activation of the sprinkler followed by activation of the blower.

19. The imaging-device cleaning system of claim 16, wherein the controller is configured to determine at least one of:
a first activation setting to activate only the blower based on a determination that the predefined blockage scenario comprises a water-spot scenario in which the substance comprises spots of water;
a second activation setting to activate the sprinkler for a first time period and to activate the blower for a second time period after an end of the first time period, based on a determination that the predefined blockage scenario comprises a solid-substance scenario in which the substance comprises a solid substance; or
a third activation setting to activate the sprinkler and the blower simultaneously, based on a determination that the predefined blockage scenario comprises a mixed-substance scenario in which the substance comprises a mixture of water and a solid substance.

20. The imaging-device cleaning system of claim 1, wherein the controller is configured to activate the blower at a blower power level, which is based on the predefined blockage scenario.

21. The imaging-device cleaning system of claim 1, wherein the controller is configured to activate an ultrasonic vibration generator to generate vibrations to at least partially remove at least one of the substance or drops of the liquid from the surface of the imaging device.

22. The imaging-device cleaning system of claim 21, wherein the controller is configured to set the ultrasonic vibration generator to generate the vibrations at a vibration frequency, which is based on the predefined blockage scenario.

23. The imaging-device cleaning system of claim 1, wherein the controller is configured to control activation of a plurality of imaging-device cleaners to clean a respective plurality of imaging-device surfaces, wherein an imaging-device cleaner of the plurality of imaging-device cleaners comprises the blower and the sprinkler.

24. The imaging-device cleaning system of claim 1, wherein the surface of the imaging device comprises a lens surface of a lens of the imaging device, or wherein the surface of the imaging device comprises a protective surface to protect the lens of the imaging device.

25. A vehicle comprising:
one or more imaging devices;
an imaging-device cleaning system configured to clean a surface of at least one imaging device of the one or more imaging devices, the imaging-device cleaning system comprising:
a blower configured to provide an airflow to be applied onto the surface of the imaging device;
a sprinkler configured to sprinkle a liquid onto the surface of the imaging device; and
a controller configured to control activation and deactivation of the blower and the sprinkler, the controller configured to control activation of at least one of the blower or the sprinkler based on identification of a predefined blockage scenario in which at least part of a field of view of the imaging device is to be blocked by a substance on the surface;
at least one processor to generate sensor information based on one or more images sensed by the one or more imaging devices; and
a vehicle system controller to control one or more vehicular systems of the vehicle based on the sensor information.

26. The vehicle of claim 25 comprising two or more imaging-device cleaners to clean surfaces of two or more respective imaging-devices, wherein an imaging-device cleaner of the two or more imaging-device cleaners comprises the blower and the sprinkler, wherein the controller is configured to control activation of the two or more imaging-device cleaners.
